(19) United States
(12) Patent Application Publication
(10) Pub. No.: US 2025/0024124 A1
(43) Pub. Date: Jan. 16, 2025

(54) INFORMATION PROCESSING APPARATUS AND INFORMATION PROCESSING METHOD

(71) Applicant: FUJIFILM Corporation, Tokyo (JP)

(72) Inventors: Masaru KOBAYASHI, Saitama-shi (JP); Kei YAMAJI, Saitama-shi (JP); Toshiki KOBAYASHI, Saitama-shi (JP)

(73) Assignee: FUJIFILM Corporation, Tokyo (JP)

(21) Appl. No.: 18/897,134

(22) Filed: Sep. 26, 2024

Related U.S. Application Data
(63) Continuation of application No. PCT/JP2023/005307, filed on Feb. 15, 2023.

(30) Foreign Application Priority Data
Mar. 30, 2022 (JP) 2022-057529

(51) Int. Cl. H04N 23/11

(52) U.S. Cl. CPC H04N 23/11

(57) ABSTRACT

An information processing method includes a linking step of linking first imaging processing of generating a first image file including first image data obtained by imaging a first subject with second imaging processing of generating a second image file including second image data obtained by imaging a second subject, an acquisition step of acquiring first subject information related to the first subject, and an assignment step of including the first subject information in second accessory information recorded in the second image file to assign the first subject information to the second image file.

### CROSS-REFERENCE TO RELATED APPLICATIONS

This application is a continuation application of International Application No. PCT/JP2023/005307, filed Feb. 15, 2023, the disclosure of which is incorporated herein by reference in its entirety. Further, this application claims priority from Japanese Patent Application No. 2022-057529, filed Mar. 30, 2022, the disclosure of which is incorporated herein by reference in its entirety.

### BACKGROUND

### 1. Technical Field

The present disclosed technology relates to an information processing apparatus and an information processing method.

### 2. Related Art

WO2004/061387A discloses a video capture system that acquires video information of an object from a multi-viewpoint. The video capture system disclosed in WO2004/061387A comprises a camera, detection means, synchronization means, data addition means, and calibration means. The camera is a plurality of three-dimensionally movable cameras that acquire video data of a moving image. The detection means acquires a camera parameter for each camera. The synchronization means synchronizes the plurality of cameras. The data addition means adds association information between pieces of video data of synchronized moving images of respective cameras and between the video data of the moving image and the camera parameter. The calibration means calibrates the video data of each moving image with the camera parameter corresponding to the video data based on the association information to obtain information for analyzing a movement and posture of the object.

The video capture system disclosed in WO2004/061387A comprises video data storage means and camera parameter storage means. The video data storage means stores, for each frame, the video data to which the association information is added. The camera parameter storage means stores the camera parameter to which the association information is added. The association information is a frame count of the video data of the moving image acquired from one camera of the plurality of cameras.

JP2004-072349A discloses an imaging apparatus comprising first imaging means, second imaging means, first visual field control means, and a second visual field control means. In the imaging apparatus disclosed in JP2019-041972A, the first imaging means images a first direction, and the second imaging means images a second direction. The first visual field control means controls a visual field of the first imaging means to a different first visual field. The second visual field control means controls the visual field of the second imaging means to be adjacent to the first visual field in a horizontal plane. In the imaging apparatus disclosed in JP2004-072349A, the first visual field control means and the second visual field control means do not share a ridge line with each other, and a lens center of virtual imaging means having the first visual field substantially matches a lens center of virtual imaging means having the second visual field.

Further, JP2014-011633A discloses a wireless synchronization system using a plurality of imaging apparatuses, and JP2017-135754A discloses an imaging system using a plurality of cameras.

### SUMMARY

One embodiment according to the present disclosed technology provides an information processing apparatus and an information processing method capable of improving convenience of an image file.

A first aspect according to the present disclosed technology relates to an information processing method comprising a linking step of linking first imaging processing of generating a first image file including first image data obtained by imaging a first subject with second imaging processing of generating a second image file including second image data obtained by imaging a second subject, an acquisition step of acquiring first subject information related to the first subject, and an assignment step of including the first subject information in second accessory information recorded in the second image file to assign the first subject information to the second image file.

A second aspect according to the present disclosed technology relates to an information processing apparatus comprising a processor, in which the processor is configured to link first imaging processing of generating a first image file including first image data obtained by imaging a first subject with second imaging processing of generating a second image file including second image data obtained by imaging a second subject, acquire first subject information related to the first subject, and include the first subject information in second accessory information recorded in the second image file to assign the first subject information to the second image file.

### BRIEF DESCRIPTION OF THE DRAWINGS

Exemplary embodiments according to the technique of the present disclosure will be described in detail based on the following figures, wherein:

FIG. 1 is a conceptual diagram showing an example of an aspect in which an imaging system is used;

FIG. 2 is a block diagram showing an example of a hardware configuration of an electric system of the imaging system;

FIG. 3 is a block diagram showing examples of functions of a processor of a first imaging apparatus and functions of a processor of a second imaging apparatus;

FIG. 4 is a conceptual diagram showing an example of processing contents of a first linking unit and a first generation unit;

FIG. 5 is a conceptual diagram showing an example of processing contents of the first generation unit and a first acquisition unit;

FIG. 6 is a conceptual diagram showing an example of a processing content of a first assignment unit;

FIG. 7 is a conceptual diagram showing an example of a hierarchical structure of first subject information, which is recorded in first metadata 60 of a first moving image file;

FIG. 8 is a conceptual diagram showing an example of processing contents of the first linking unit and the first assignment unit;

FIG. 9 is a conceptual diagram showing an example of processing contents of a second linking unit and a second generation unit;

FIG. 10 is a conceptual diagram showing an example of processing contents of the second generation unit and a second acquisition unit;

FIG. 11 is a conceptual diagram showing an example of a processing content of a second assignment unit;

FIG. 12 is a conceptual diagram showing an example of processing contents of the second linking unit, the second acquisition unit, and the second assignment unit;

FIG. 13 is a conceptual diagram showing an example of processing contents of the second linking unit and the second assignment unit;

FIG. 14 is a conceptual diagram showing an example of processing contents of the first linking unit, the first acquisition unit, and the first assignment unit;

FIG. 15 is a conceptual diagram showing an example of processing contents of a first control unit and a second control unit;

FIG. 16 is a flowchart showing an example of a flow of first image file creation processing;

FIG. 17 is a flowchart showing an example of a flow of second image file creation processing;

FIG. 18 is a conceptual diagram showing an example of a processing content in a case where identification information is transmitted from the first imaging apparatus to the second imaging apparatus in the first imaging apparatus and the second imaging apparatus according to a first modification example;

FIG. 19 is a conceptual diagram showing an example of a processing content in a case where first time information is transmitted from the first imaging apparatus to the second imaging apparatus in the first imaging apparatus and the second imaging apparatus according to a second modification example;

FIG. 20 is a conceptual diagram showing an example of a processing content in a case where second time information is transmitted from the second imaging apparatus to the first imaging apparatus in the first imaging apparatus and the second imaging apparatus according to the second modification example;

FIG. 21 is a conceptual diagram showing an example of a processing content of the first imaging apparatus according to a third modification example;

FIG. 22 is a conceptual diagram showing an example of a processing content in a case where first imaging apparatus-related information is transmitted from the first imaging apparatus to the second imaging apparatus in the first imaging apparatus and the second imaging apparatus according to the third modification example;

FIG. 23 is a conceptual diagram showing an example of a processing content of the second imaging apparatus according to the third modification example;

FIG. 24 is a conceptual diagram showing an example of a processing content in a case where second imaging apparatus-related information is transmitted from the second imaging apparatus to the first imaging apparatus in the first imaging apparatus and the second imaging apparatus according to the third modification example;

FIG. 25 is a conceptual diagram showing an example of an aspect in which the imaging system according to a fourth modification example is used;

FIG. 26 is a conceptual diagram showing an example of a processing content in a case where thermal image-related information is transmitted from the first imaging apparatus to the second imaging apparatus in the first imaging apparatus and the second imaging apparatus according to the fourth modification example;

FIG. 27 is a conceptual diagram showing an example of a processing content in a case where visible light-related information is transmitted from the second imaging apparatus to the first imaging apparatus in the first imaging apparatus and the second imaging apparatus according to the fourth modification example;

FIG. 28 is a conceptual diagram showing an example of an aspect in which a distance image is generated by the first imaging apparatus according to the fourth modification example;

FIG. 29 is a conceptual diagram showing an example of a processing content in a case where distance image-related information is transmitted from the first imaging apparatus to the second imaging apparatus in the first imaging apparatus and the second imaging apparatus according to the fourth modification example;

FIG. 30 is a conceptual diagram showing an example of an aspect in which the first imaging apparatus is applied as a front camera of a vehicle and the second imaging apparatus is applied as a rear camera of the vehicle;

FIG. 31 is a conceptual diagram showing an example of an aspect in which the image file creation processing is executed on an external device; and

FIG. 32 is a conceptual diagram showing an example of a structure of a still image file.

### DETAILED DESCRIPTION

Hereinafter, an example of embodiments of an information processing method and an information processing apparatus according to the present disclosed technology will be described with reference to accompanying drawings.

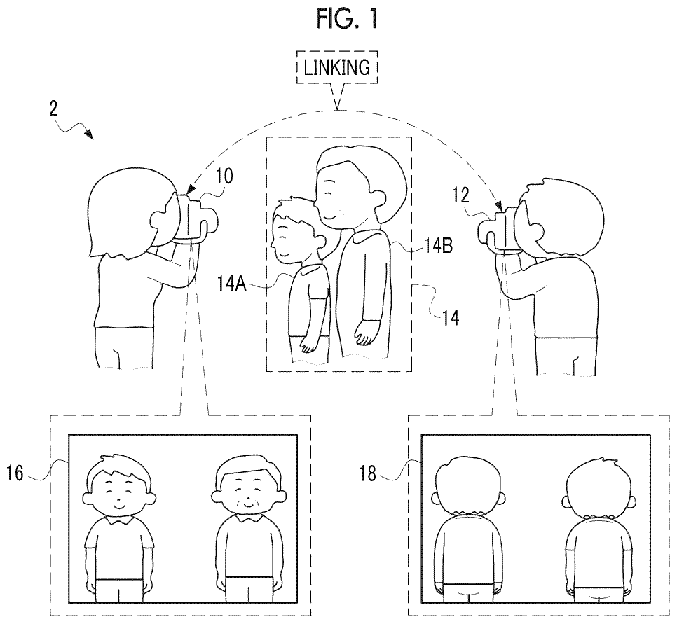

As shown in FIG. 1 as an example, an imaging system 2 comprises a first imaging apparatus 10 and a second imaging apparatus 12. The imaging system 2 performs processing by causing the first imaging apparatus 10 and the second imaging apparatus 12 to link with each other. In the imaging system 2, the first imaging apparatus 10 and the second imaging apparatus 12 image a subject 14, which is a common subject. The first imaging apparatus 10 is an example of “first imaging apparatus” according to the present disclosed technology. Further, the second imaging apparatus 12 is an example of “second imaging apparatus” according to the present disclosed technology. Further, the subject 14 is an example of “first subject”, “second subject”, and “common subject” according to the present disclosed technology.

In the example shown in FIG. 1, the first imaging apparatus 10 and the second imaging apparatus 12 are digital cameras for consumer use. An example of the digital camera for consumer use includes a lens-interchangeable digital camera or a lens-fixed digital camera. Further, the first imaging apparatus 10 and the second imaging apparatus 12 may be digital cameras for industrial use. Further, the first imaging apparatus 10 and the second imaging apparatus 12 may be imaging apparatuses mounted on various electronic apparatuses, such as a smart device, a wearable terminal, a cell observation device, an ophthalmic observation device, and a surgical microscope.

Further, the first imaging apparatus 10 and the second imaging apparatus 12 may be imaging apparatuses mounted on various modalities, such as an endoscope apparatus, an ultrasound diagnostic apparatus, an X-ray imaging apparatus, a computed tomography (CT) apparatus, and a magnetic resonance imaging (MRI) apparatus.

In the example shown in FIG. 1, the subject 14 includes person subjects 14A and 14B. The person subjects 14A and 14B face a first imaging apparatus 10 side and are in a state of turning their backs to the second imaging apparatus 12. In the example shown in FIG. 1, an aspect is shown in which the first imaging apparatus 10 images the person subjects 14A and 14B from a front side and the second imaging apparatus 12 images the person subjects 14A and 14B from a rear side.

The first imaging apparatus 10 images the subject 14 to generate image data 16 indicating an image in which the subject 14 is shown. The image data 16 is obtained by imaging the person subject 14A and the person subject 14B from the front side by the first imaging apparatus 10. The image indicated by the image data 16 shows an aspect of the front side of the person subjects 14A and 14B.

The second imaging apparatus 12 images the subject 14 to generate image data 18 indicating the image in which the subject 14 is shown. The image data 18 is obtained by imaging the person subject 14A and the person subject 14B from the rear side by the second imaging apparatus 12. The image indicated by the image data 18 shows an aspect of the rear side of the person subjects 14A and 14B.

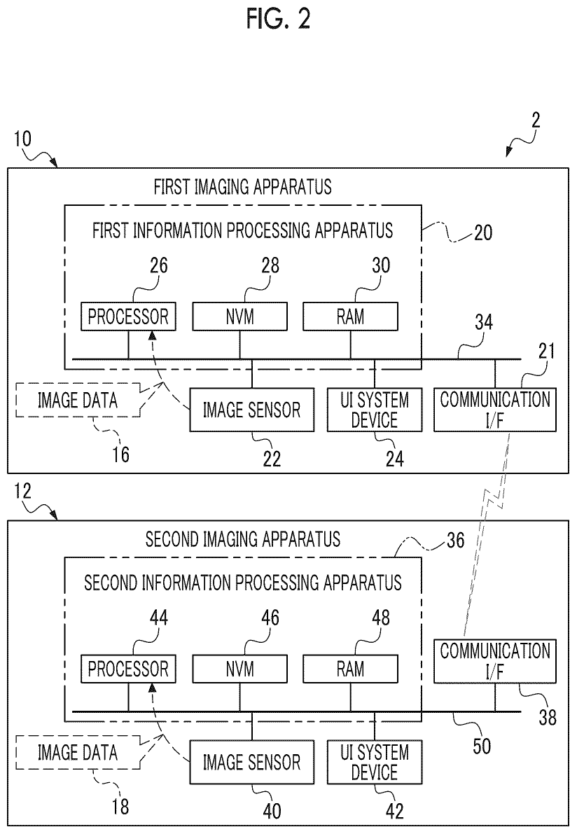

As shown in FIG. 2 as an example, the first imaging apparatus 10 comprises a first information processing apparatus 20, a communication interface (I/F) 21, an image sensor 22, and a UI system device 24.

The first information processing apparatus 20 comprises a processor 26, a non-volatile memory (NVM) 28, and a random access memory (RAM) 30. The processor 26, the NVM 28, and the RAM 30 are connected to a bus 34.

The processor 26 is a processing device including a digital signal processor (DSP), a central processing unit (CPU), and a graphics processing unit (GPU). The DSP and the GPU operate under control of the CPU and are responsible for execution of processing related to the image.

Here, the processing device including the DSP, the CPU, and the GPU is described as an example of the processor 26, but this is merely an example. The processor 26 may be one or more CPUs and DSPs that integrate GPU functions, may be one or more CPUs and DSPs that do not integrate the GPU functions, or may be provided with a tensor processing unit (TPU).

The NVM 28 is a non-volatile storage device that stores various programs, various parameters, and the like. An example of the NVM 28 includes a flash memory (for example, electrically erasable and programmable read only memory (EEPROM)).

The RAM 30 is a memory in which information is temporarily stored and is used as a work memory by the processor 26. An example of the RAM 30 includes a dynamic random access memory (DRAM) or a static random access memory (SRAM).

The communication I/F 21 is an interface including a communication processor, an antenna, and the like, and is connected to the bus 34. A communication standard applied to the communication I/F 21 is, for example, a wireless communication standard including a 5th generation mobile communication system (5G), Wi-Fi (registered trademark), or Bluetooth (registered trademark).

The image sensor 22 is connected to the bus 34. An example of the image sensor 22 includes a complementary metal oxide semiconductor (CMOS) image sensor.

The image sensor 22 images the subject 14 (refer to FIG. 1) to generate the image data 16, under the control of the processor 26. A type of the image data 16 is, for example, visible light image data obtained by imaging the subject 14 in a visible light range. However, the type of the image data 16 is not limited thereto, and may be invisible light image data obtained by imaging the subject 14 in a wavelength range other than the visible light range.

An A/D converter (not shown) is incorporated in the image sensor 22, and the image sensor 22 digitizes the analog image data, which is obtained by imaging the subject 14, to generate the image data 16. The image data 16 generated by the image sensor 22 is acquired and processed by the processor 26.

Here, an example of the image sensor 22 includes the CMOS image sensor, but this is merely an example. The image sensor 22 may be another type of image sensor such as a charge coupled device (CCD) image sensor.

Further, here, the embodiment example has been described in which the subject 14 is imaged in the visible light range by the image sensor 22, but this is merely an example. The subject 14 may be imaged in a wavelength range other than the visible light range.

The user interface (UI) system device 24 has a reception function of receiving an instruction from a user and a presentation function of presenting information to the user. The reception function is realized by, for example, a touch panel and a hard key (for example, release button and menu selection key). The presentation function is realized by, for example, a display and a speaker.

The second imaging apparatus 12 comprises a second information processing apparatus 36 corresponding to the first information processing apparatus 20, a communication I/F 38 corresponding to the communication I/F 21, an image sensor 40 corresponding to the image sensor 22, and a UI system device 42 corresponding to the UI system device 24. The second information processing apparatus 36 comprises a processor 44 corresponding to the processor 26, an NVM 46 corresponding to the NVM 28, and a RAM 48 corresponding to the RAM 30. As described above, the second imaging apparatus 12 includes the same plurality of hardware resources as the first imaging apparatus 10. Therefore, here, the description of the plurality of hardware resources included in the second imaging apparatus 12 will be omitted. The first information processing apparatus 20 and the second information processing apparatus 36 are examples of “information processing apparatus” according to the present disclosed technology. The processors 26 and 44 are an example of “processor” according to the present disclosed technology.

Meanwhile, the first imaging apparatus 10 and the second imaging apparatus 12 perform the imaging in a moving image capturing mode that is an operation mode for performing the imaging in accordance with a predetermined frame rate (for example, several tens of frames/second) to generate a moving image file including moving image data. In the moving image file generated by the first imaging apparatus 10, the information obtained by the first imaging apparatus 10 is recorded as metadata. In the moving image file generated by the second imaging apparatus 12, the information obtained by the second imaging apparatus 12 is recorded as metadata. That is, there is no relevance between the information included in the metadata of the moving image file generated by the first imaging apparatus 10 and the information included in the metadata of the moving image file generated by the second imaging apparatus 12. Therefore, for example, in a case where the user or the like who performs the processing on one moving image file wants to refer to the information included in the other moving image file, it takes time to reproduce the other moving image file or to search for necessary information from the metadata in the other moving image file.

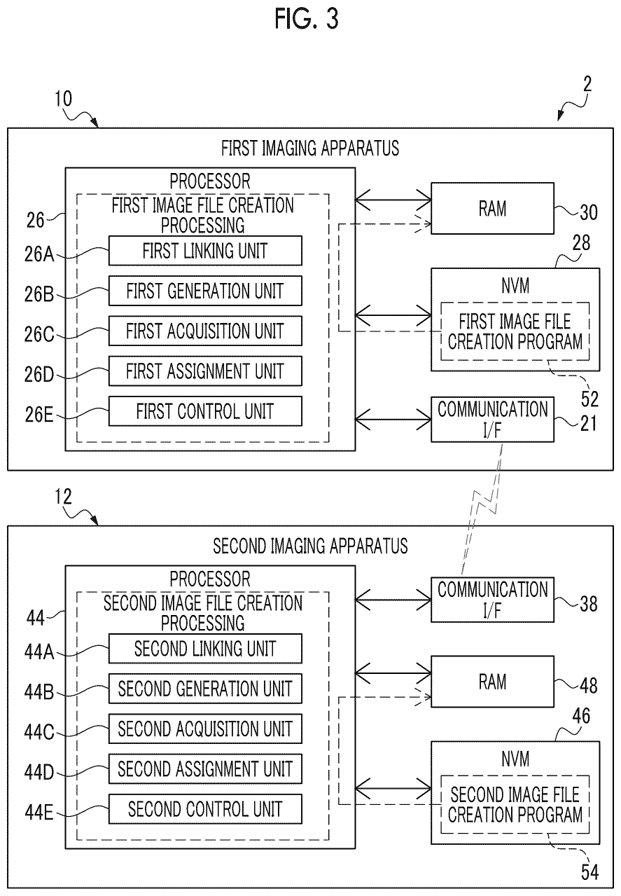

In consideration of such circumstances, in the imaging system 2, as shown in FIG. 3 as an example, the processor 26 of the first imaging apparatus 10 performs first image file creation processing, and the processor 44 of the second imaging apparatus 12 performs second image file creation processing. Further, communication is performed between the first imaging apparatus 10 and the second imaging apparatus 12 via the communication I/Fs 21 and 38, and thus the first image file creation processing and the second image file creation processing are performed in a linked manner.

In the first imaging apparatus 10, the NVM 28 stores a first image file creation program 52. The processor 26 reads out the first image file creation program 52 from the NVM 28 and executes the readout first image file creation program 52 on the RAM 30 to perform the first image file creation processing. The first image file creation processing is realized by the processor 26 operating as a first linking unit 26A, a first generation unit 26B, a first acquisition unit 26C, a first assignment unit 26D, and a first control unit 26E in accordance with the first image file creation program 52 executed on the RAM 30.

In the second imaging apparatus 12, the NVM 46 stores a second image file creation program 54. The processor 44 reads out the second image file creation program 54 from the NVM 46 and executes the readout second image file creation program 54 on the RAM 48 to perform the second image file creation processing. The second image file creation processing is realized by the processor 44 operating as a second linking unit 44A, a second generation unit 44B, a second acquisition unit 44C, a second assignment unit 44D, and a second control unit 44E in accordance with the second image file creation program 54 executed on the RAM 48.

In the present embodiment, the first image file creation processing is an example of “first imaging processing” according to the present disclosed technology. The second image file creation processing is an example of “second imaging processing” according to the present disclosed technology. Processing performed by the first linking unit 26A and processing performed by the second linking unit 44A are examples of “linking step” according to the present disclosed technology. Processing performed by the first acquisition unit 26C and processing performed by the second acquisition unit 44C are examples of “acquisition step” according to the present disclosed technology. Processing performed by the first assignment unit 26D and processing performed by the second assignment unit 44D are examples of “assignment step” according to the present disclosed technology.

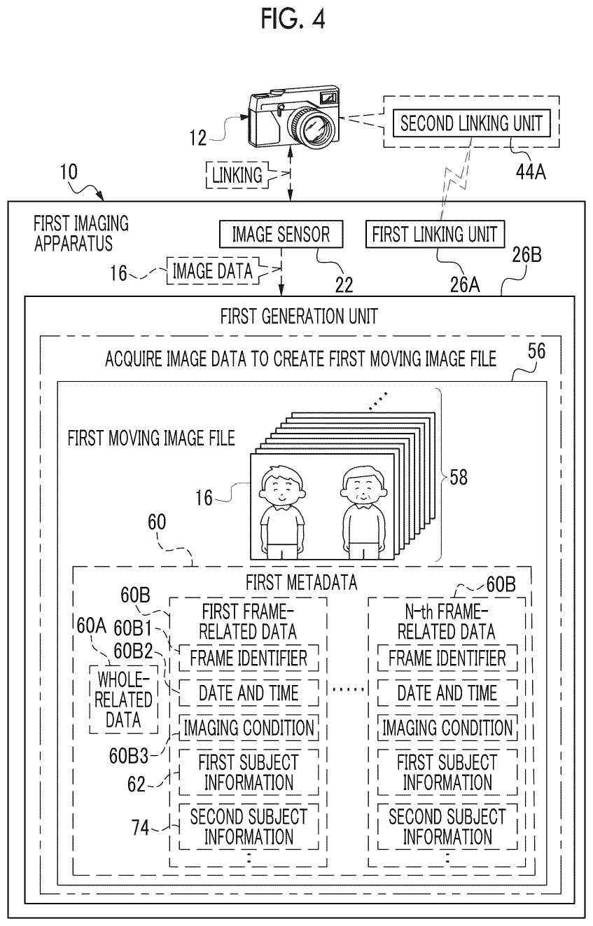

As shown in FIG. 4 as an example, the first linking unit 26A of the first imaging apparatus 10 establishes the communication with the second linking unit 44A of the second imaging apparatus 12 via the communication I/Fs 21 and 38 (refer to FIGS. 2 and 3). The first linking unit 26A performs the communication with the second linking unit 44A to link the first image file creation processing (refer to FIG. 3) performed by the first imaging apparatus 10 with the second image file creation processing (refer to FIG. 3) performed by the second imaging apparatus 12.

The first generation unit 26B acquires the image data 16 of a plurality of frames from the image sensor 22 and generates a first moving image file 56 based on the acquired image data 16 of the plurality of frames. The first moving image file 56 includes first moving image data 58 and first metadata 60. The first moving image data 58 includes the image data 16 of the plurality of frames.

In the present embodiment, the image data 16 is an example of “first frame” according to the present disclosed technology. The image data 16 of the plurality of frames is an example of “plurality of first frames” according to the present disclosed technology. The first moving image data 58 is an example of “moving image data configured of the plurality of first frames”, “first image data”, and “first moving image data” according to the present disclosed technology. The first moving image file 56 is an example of “first image file” and “first moving image file” according to the present disclosed technology.

The first metadata 60 is data related to the first moving image file 56 (that is, data accessory to first moving image data 58) and is recorded in the first moving image file 56. The first metadata 60 is an example of “first accessory information” according to the present disclosed technology.

The first metadata 60 includes whole-related data 60A and a plurality of pieces of frame-related data 60B. The whole-related data 60A relates to the whole of the first moving image file 56. The whole-related data 60A includes, for example, an identifier uniquely attached to the first moving image file 56, a time point at which the first moving image file 56 is created, a time required for reproducing the first moving image file 56, a bit rate of the first moving image data 58, and a codec.

The plurality of pieces of frame-related data 60B correspond to the image data 16 of the plurality of frames included in the first moving image data 58 on a one-to-one basis. The frame-related data 60B includes data related to the corresponding image data 16. The frame-related data 60B includes, for example, a frame identifier 60B1, a date and time 60B2, an imaging condition 60B3, first subject information 62, and second subject information 74. The frame identifier 60B1 can identify the frame. The date and time 60B2 is a date and time at which the frame (that is, the image data 16) corresponding to the frame-related data 60B is obtained. The imaging condition 60B3 is an imaging condition (for example, stop, shutter speed, sensitivity of the image sensor 22, 35 mm equivalent focal length, and ON/OFF of camera-shake correction) set for the first imaging apparatus 10. The first subject information 62 relates to the subject included in each frame configuring the first moving image data 58. The second subject information 74 is transmitted from the second linking unit 44A and received by the first imaging apparatus 10 via the first linking unit 26A. Details of the first subject information 62 and the second subject information 74 will be described below.

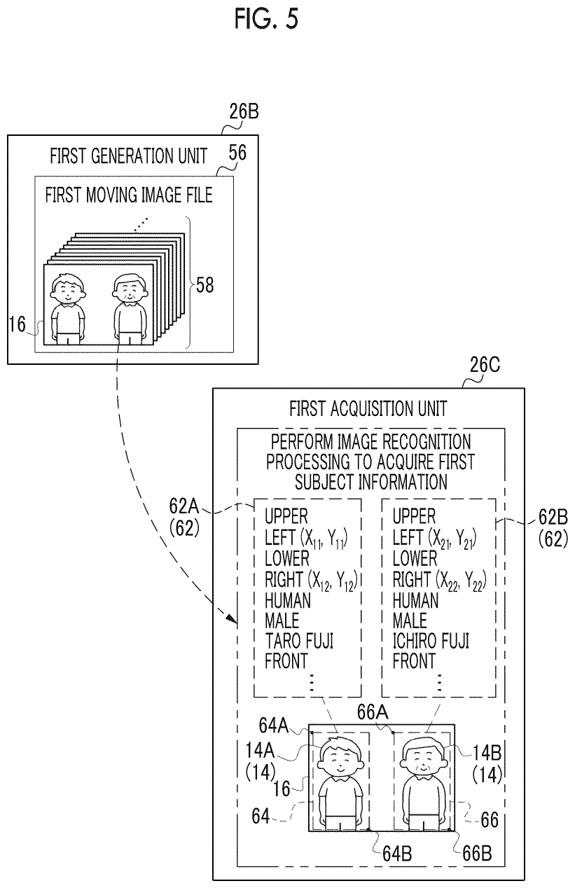

As shown in FIG. 5 as an example, the first acquisition unit 26C acquires the image data 16 in one-frame unit in a time series manner from the moving image data 58 of the first moving image file 56. The first acquisition unit 26C performs image recognition processing of an artificial intelligence (AI) type on the acquired image data 16 to acquire first subject information 62, which is information related to the subject 14. The first subject information 62 is various pieces of information obtained by performing the image recognition processing of the AI type on the image data 16. Here, the image recognition processing of the AI type is described as an example, but this is merely an example. Instead of the image recognition processing of the AI type or together with the image recognition processing of the AI type, other types of image recognition processing, such as the image recognition processing of a template matching type, may be performed.

In the example shown in FIG. 5, first subject information 62A related to the person subject 14A and first subject information 62B related to the person subject 14B are shown as the first subject information 62. The first subject information 62A includes coordinate information, subject type information, subject attribute information, and the like. In a case where the image recognition processing of the AI type is performed using a convolutional neural network (CNN), the first subject information 62A may include, as the information related to the person subject 14B (for example, subject attribute information), a gradient-weighted class activation mapping (CAM) image, a feature amount map obtained from a convolutional layer, a confidence degree (that is, score) output from the CNN, or the like.

The coordinate information included in the first subject information 62A is information related to coordinates that can specify a position of the person subject 14A, which is shown in the image indicated by the image data 16, in the image (for example, position in a two-dimensional coordinate plane with an origin at an upper left corner of the image indicated by the image data 16). Examples of the coordinates included in the first subject information 62A include coordinates of a front-view upper left corner 64A of a bounding box 64 and coordinates of a front-view lower right corner 64B of the bounding box 64, which are obtained from the image recognition processing of the AI type on the person subject 14A.

The subject type information included in the first subject information 62A indicates a type of the person subject 14A in the bounding box 64. The first subject information 62A includes, as the subject type information, a biological category (“human” in the example shown in FIG. 5), a gender category (“male” in the example shown in FIG. 5), a name category (name “Taro Fuji” in the example shown in FIG. 5), and the like. Further, the first subject information 62A includes, as the subject attribute information, an orientation category (“front” in the example shown in FIG. 5) and the like. Here, the embodiment example has been described in which the gender category and the name category belong to the subject type information, but this is merely an example. The gender category and the name category may belong to the subject attribute information.

The second subject information 62B is configured in the same manner as the first subject information 62B. In the example shown in FIG. 5, examples of the coordinates included in the second subject information 62B include coordinates of a front-view upper left corner 66A of a bounding box 66 and coordinates of a front-view lower right corner 66B of the bounding box 66, which are obtained from the AI-based image recognition processing on the person 14B. Further, a name “Ichiro Fuji” is assigned to the name category of the second subject information 62B.

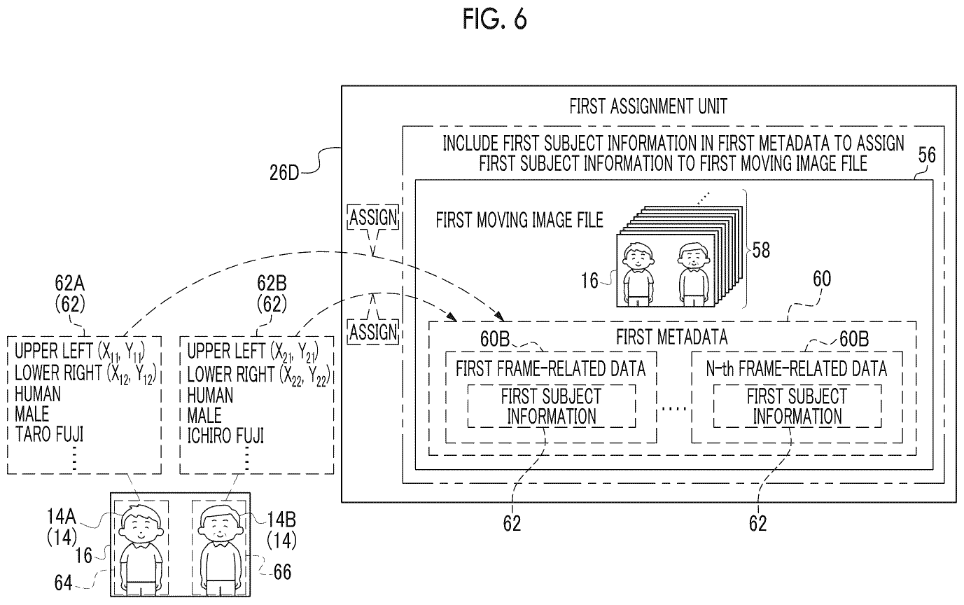

As shown in FIG. 6 as an example, the first assignment unit 26D includes the first subject information 62 in the first metadata 60 to assign the first subject information 62 to the first moving image file 56. For example, the first assignment unit 26D includes the first subject information 62 corresponding to the image data 16 in the frame-related data 60B corresponding to the image data 16 to assign the first subject information 62 to the first moving image file 56. The first subject information 62 is assigned to the first moving image file 56 for each piece of image data 16 included in the first moving image data 58.

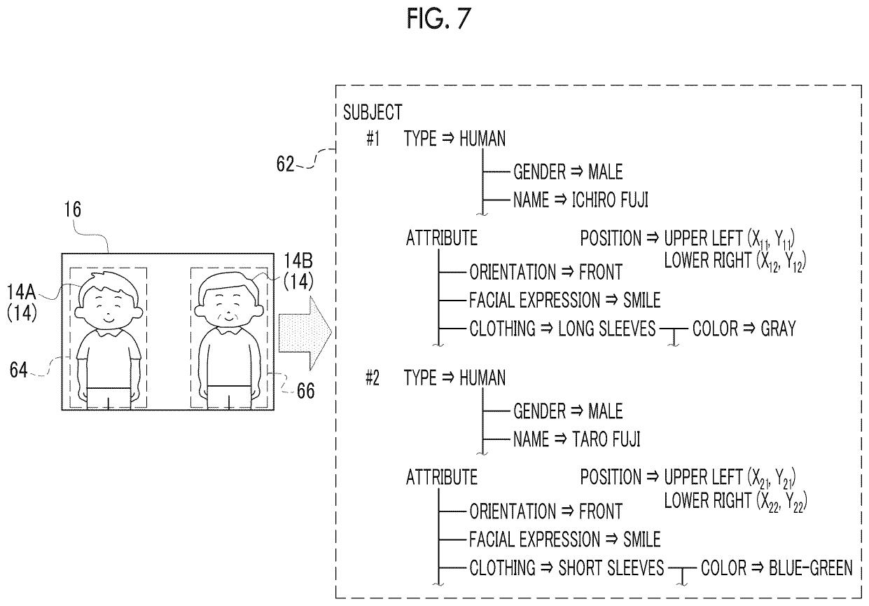

As shown in FIG. 7 as an example, a plurality of pieces of information included in the first subject information 62, which is assigned to the first moving image file 56, are classified into a plurality of categories. For example, a subject identifier (“#1” and “#2” in the example shown in FIG. 7), which is an identifier unique to each subject included in the subject 14, is attached. The plurality of categories, such as a type category, an attribute category, and a position category, are assigned to the subject identifier. In the example shown in FIG. 7, the plurality of categories are provided for each of the type category and the attribute category in a hierarchical manner. In a lower hierarchy, a category of a lower-level concept or derived concept of an upper hierarchy is provided. Further, in the example shown in FIG. 7, the first subject information 62A is assigned to “#1”, and the second subject information 62B is assigned to “#2”.

The type category indicates a type of the subject. The subject type information included in the first subject information 62A is classified into the type category. In the example shown in FIG. 7, “human” is assigned to the type category as the type of the subject. In a lower hierarchy than the type category, the gender category and the name category are provided. The gender category indicates gender, and the name category indicates a name of the subject (for example, a general noun or a proper noun).

The attribute category indicates an attribute of the subject. The subject attribute information included in the first subject information 62A is classified into the attribute category. In the example shown in FIG. 7, the orientation category, a facial expression category, and a clothing category are provided, and a color category is provided as a lower hierarchy of the clothing category. The orientation category indicates an orientation of the subject. The expression category indicates a facial expression of the subject. The clothing category indicates a type of clothing worn by the subject. The color category indicates a color of clothing worn by the subject.

The position category indicates a position of the subject in the image. The coordinates included in the first subject information 62A are classified into the position category. In the example shown in FIG. 7, the coordinates included in the first subject information 62A are assigned to “#1”, and the coordinates included in the first subject information 62B are assigned to “#2”.

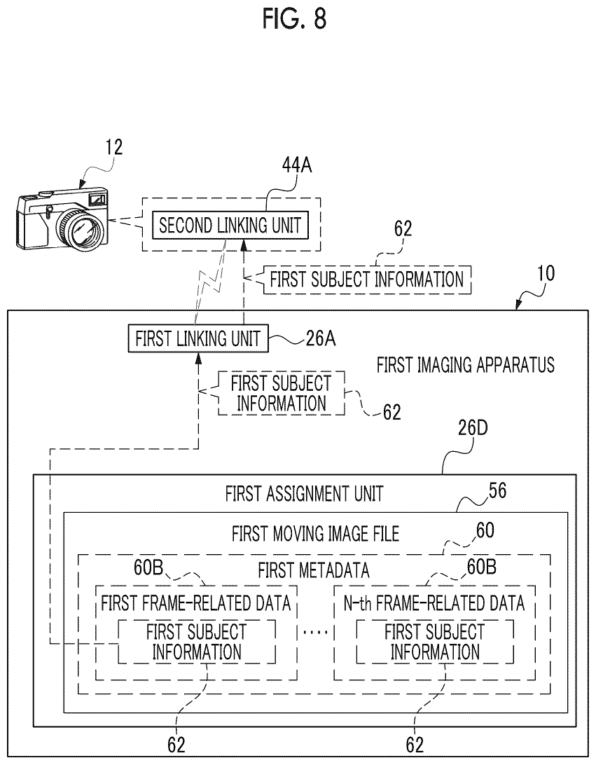

As shown in FIG. 8 as an example, each time the first subject information 62 is assigned to the first moving image file 56 in units of the image data 16, the first assignment unit 26D transmits the same first subject information 62 to the second linking unit 44A of the second imaging apparatus 12 via the first linking unit 26A. That is, each time the first subject information 62 is included in the frame-related data 60B in units of the image data 16 by the first assignment unit 26D, the same first subject information 62 as the first subject information 62 included in the frame-related data 60B is transmitted to the second imaging apparatus 12 from the first imaging apparatus 10. The first subject information 62 may be transmitted to the second linking unit 44A after recording of the first moving image file 56 is completed.

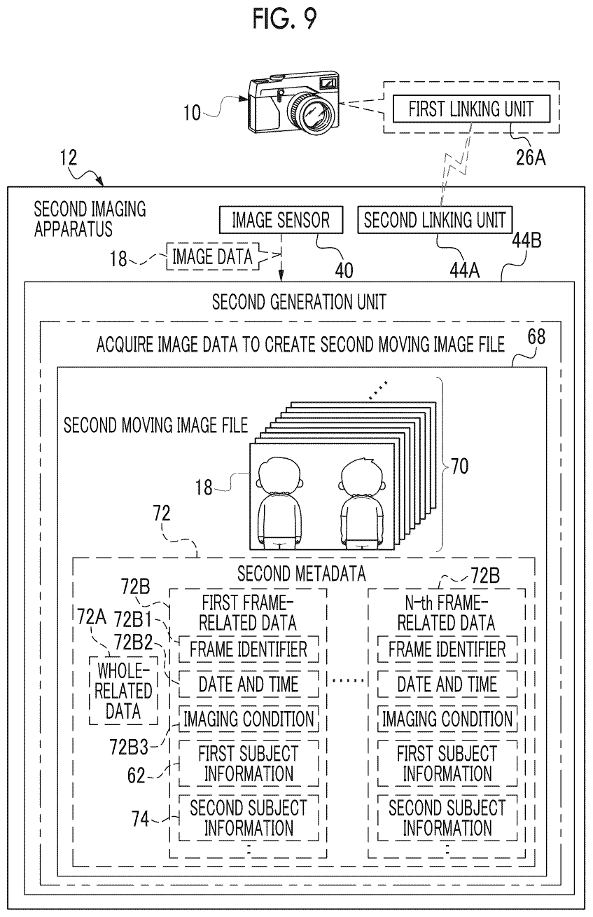

As shown in FIG. 9 as an example, the second linking unit 44A of the second imaging apparatus 12 establishes the communication with the first linking unit 26A of the first imaging apparatus 10 via the communication I/Fs 21 and 38 (refer to FIGS. 2 and 3). The second linking unit 44A performs the communication with the first linking unit 26A to link the second image file creation processing (refer to FIG. 3) performed by the second imaging apparatus 12 with the first image file creation processing (refer to FIG. 3) performed by the first imaging apparatus 10.

The second generation unit 44B acquires the image data 18 of a plurality of frames from the image sensor 40 and generates a second moving image file 68 based on the acquired image data 18 of the plurality of frames.

The second moving image file 68 is a moving image file including second moving image data 70 and second metadata 72. The second moving image data 70 includes the image data 18 of the plurality of frames.

In the present embodiment, the image data 18 is an example of “second frame” according to the present disclosed technology. The image data 18 of the plurality of frames is an example of “plurality of second frames” according to the present disclosed technology. The second moving image data 70 is an example of “moving image data configured of the plurality of second frames”, “second image data”, and “second moving image data” according to the present disclosed technology. The second moving image file 68 is an example of “second image file” and “second moving image file” according to the present disclosed technology.

The second metadata 72 is data related to the second moving image file 68 (that is, data accessory to the second moving image data 70) and is recorded in the second moving image file 68. The second metadata 72 is an example of “second accessory information” according to the present disclosed technology.

The second metadata 72 includes whole-related data 72A and a plurality of pieces of frame-related data 72B. The whole-related data 72A relates to the whole of the second moving image file 68. The whole-related data 72A includes, for example, an identifier uniquely attached to the second moving image file 68, a time point at which the second moving image file 68 is created, a time required for reproducing the second moving image file 68, a bit rate of the second moving image data 70, and a codec.

The plurality of pieces of frame-related data 72B correspond to the image data 18 of the plurality of frames included in the second moving image data 70 on a one-to-one basis. The frame-related data 72B includes the data related to the corresponding image data 18. The frame-related data 72B includes, for example, a frame identifier 72B1, a date and time 72B2, and an imaging condition 72B3, similarly to the first frame-related data 60B. Further, the frame-related data 72B includes the first subject information 62 and the second subject information 74, as will be described below.

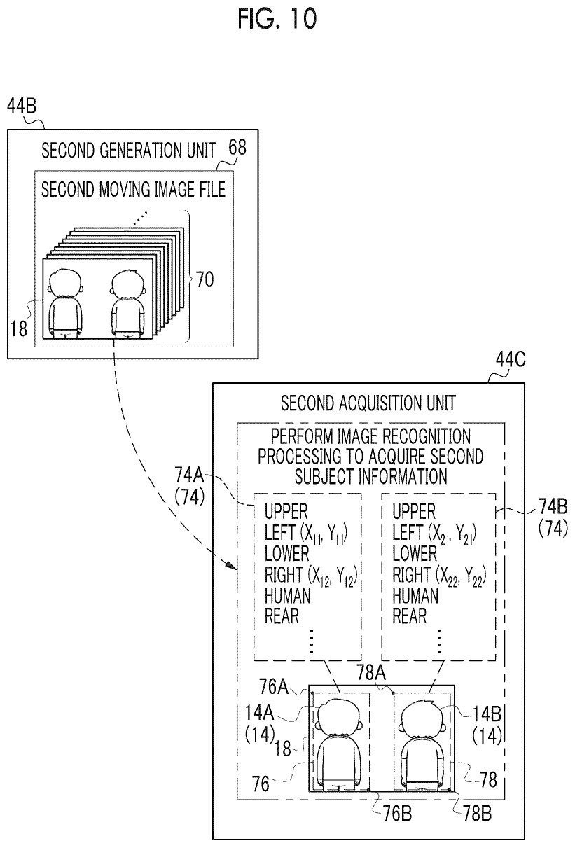

As shown in FIG. 10 as an example, the second acquisition unit 44C acquires the image data 18 in one-frame unit in a time series manner from the moving image data 70 of the second moving image file 68. The second acquisition unit 44C performs the image recognition processing of the AI type on the acquired image data 18 to acquire the second subject information 74, which the information related to the subject 14. The second subject information 74 is various pieces of information obtained by performing the image recognition processing of the AI type on the image data 18. Here, the image recognition processing of the AI type is described as an example, but this is merely an example. Instead of the image recognition processing of the AI type or together with the image recognition processing of the AI type, other types of image recognition processing, such as the image recognition processing of a template matching type, may be performed.

In the example shown in FIG. 10, second subject information 74A related to the person subject 14A and second subject information 74B related to the person subject 14B are exemplified as the second subject information 74. The second subject information 74A includes the coordinate information, the subject type information, the subject attribute information, and the like in the same specifications as those of the first subject information 62.

The subject type information included in the second subject information 74A indicates a type of the person subject 14A in a bounding box 76. The second subject information 74A includes, as the subject type information, the biological category (“human” in the example shown in FIG. 10) and the like. Further, the second subject information 74A includes, as the subject attribute information, the orientation category (“rear” in the example shown in FIG. 10) and the like.

The coordinate information included in the second subject information 74A is information related to coordinates that can specify a position of the person subject 14A, which is shown in the image indicated by the image data 18, in the image (for example, position in a two-dimensional coordinate plane with an origin at an upper left corner of the image indicated by the image data 18). Examples of the coordinates included in the second subject information 74A include coordinates of a front-view upper left corner 76A of the bounding box 76 and coordinates of a front-view lower right corner 76B of the bounding box 76, which are obtained from the image recognition processing of the AI type on the person subject 14A.

The subject type information included in the second subject information 74B indicates a type of the person subject 14B in a bounding box 78. The second subject information 74B includes, as the subject type information, the biological category (“human” in the example shown in FIG. 10) and the like. Further, the second subject information 74B includes, as the subject attribute information, the orientation category (“rear” in the example shown in FIG. 10) and the like.

The coordinate information included in the second subject information 74B is information related to coordinates that can specify a position of the person subject 14B, which is shown in the image indicated by the image data 18, in the image (for example, position in a two-dimensional coordinate plane with an origin at an upper left corner of the image indicated by the image data 18). Examples of the coordinates included in the second subject information 74B include coordinates of a front-view upper left corner 78A of the bounding box 78 and coordinates of a front-view lower right corner 78B of the bounding box 78, which are obtained from the image recognition processing of the AI type on the person subject 14B.

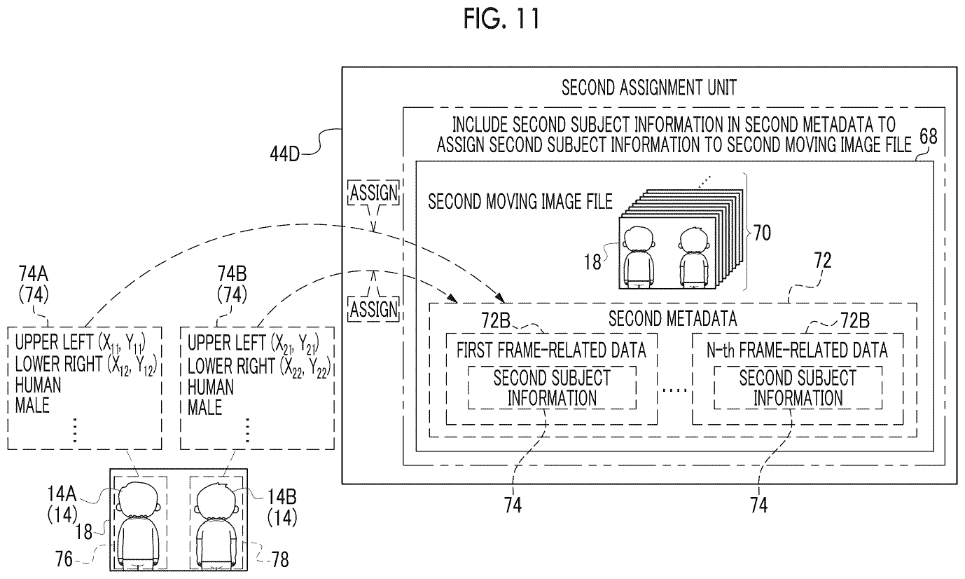

As shown in FIG. 11 as an example, the second assignment unit 44D includes the second subject information 74 in the second metadata 72 to assign the second subject information 74 to the second moving image file 68. For example, the second assignment unit 44D includes the second subject information 74 corresponding to the image data 18 in the frame-related data 72B corresponding to the image data 18 to assign the second subject information 74 to the second moving image file 68. The second subject information 74 is assigned to the second moving image file 68 for each piece of image data 18 included in the second moving image data 70. In addition, a plurality of pieces of information included in the second subject information 74, which is assigned to the second moving image file 68, are classified into a plurality of categories in the same manner as in the example shown in FIG. 7.

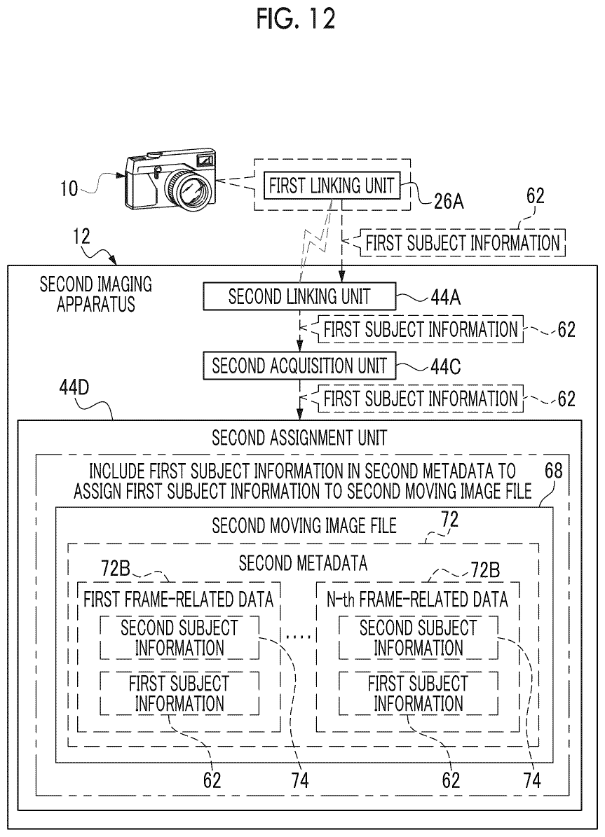

As shown in FIG. 12 as an example, in a case where the first subject information 62 is transmitted to the second imaging apparatus 12 from the first linking unit 26A of the first imaging apparatus 10 (refer to FIG. 8), the first subject information 62 is received by the second linking unit 44A of the second imaging apparatus 12. The first subject information 62 received by the second linking unit 44A is acquired by the second acquisition unit 44C.

The second assignment unit 44D includes the first subject information 62 acquired by the second acquisition unit 44C in the second metadata 72 to assign the first subject information 62 to the second moving image file 68. For example, the second assignment unit 44D includes the first subject information 62 acquired by the second acquisition unit 44C in the frame-related data 72B corresponding to the latest image data 18 to assign the first subject information 62 to the second moving image file 68. Accordingly, since the first frame-related data 72B includes the first subject information 62 in addition to the second subject information 74, the user or the like can obtain the first subject information 62, which is the information included also in the first moving image file 56, from the second moving image file 68.

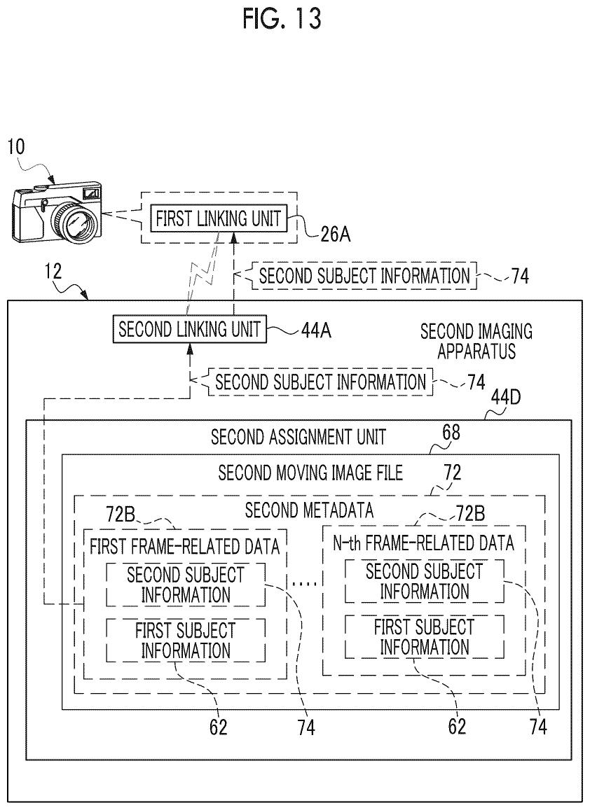

As shown in FIG. 13 as an example, each time the second subject information 74 is assigned to the second moving image file 68 in units of the image data 18, the second assignment unit 44D transmits the same second subject information 74 to the first linking unit 26A of the first imaging apparatus 10 via the second linking unit 44A. That is, each time the second subject information 74 is included in the frame-related data 72B in units of the image data 18 by the second assignment unit 44D, the same second subject information 74 as the second subject information 74 included in the frame-related data 72B is transmitted to the first imaging apparatus 10 from the second imaging apparatus 12. The second subject information 74 may be transmitted to the first linking unit 26A after recording of the second moving image file 68 is completed.

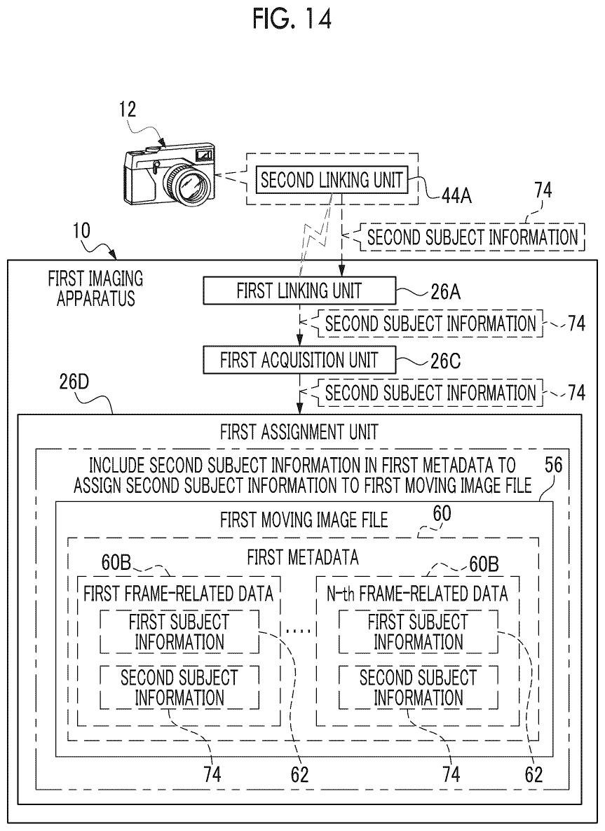

As shown in FIG. 14 as an example, in a case where the second subject information 74 is transmitted to the first imaging apparatus 10 from the second linking unit 44A of the second imaging apparatus 12 (refer to FIG. 13), the second subject information 74 is received by the first linking unit 26A of the first imaging apparatus 10. The second subject information 74 received by the first linking unit 26A is acquired by the first acquisition unit 26C.

The first assignment unit 26D includes the second subject information 74 acquired by the first acquisition unit 26C in the first metadata 60 to assign the second subject information 74 to the first moving image file 56. For example, the first assignment unit 26D includes the second subject information 74 acquired by the first acquisition unit 26C in the frame-related data 60B corresponding to the latest image data 16 to assign the second subject information 74 to the first moving image file 56. Accordingly, since the first frame-related data 60B includes the second subject information 74 in addition to the first subject information 62, the user or the like can obtain the second subject information 74, which is the information included also in the second moving image file 68, from the first moving image file 56.

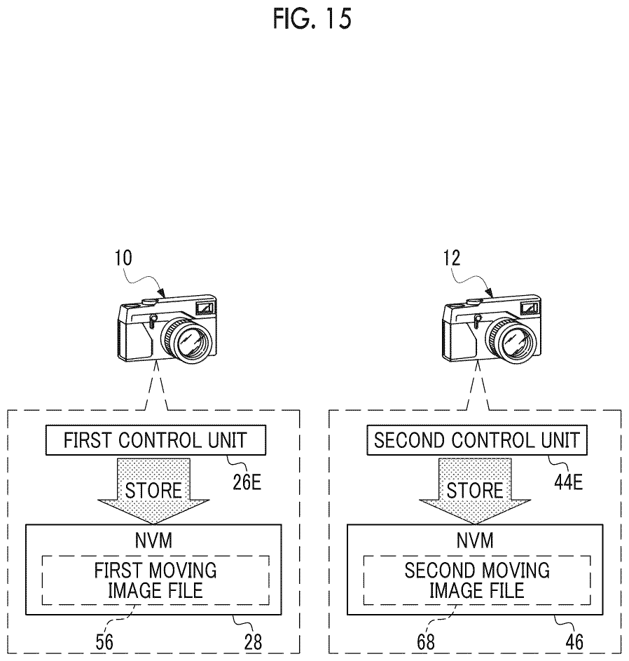

As shown in FIG. 15 as an example, in the first imaging apparatus 10, the first control unit 26E stores the first moving image file 56 obtained as described above in the NVM 28. Further, in the second imaging apparatus 12, the second control unit 44E stores the second moving image file 68 obtained as described above in the NVM 46.

In the example shown in FIG. 15, the embodiment example has been described in which the first moving image file 56 is stored in the NVM 28 and the second moving image file 68 is stored in the NVM 46, but this is merely an example. The first moving image files 56 and 68 may be stored in one or more storage media other than the NVMs 28 and 46. The storage medium may be used by being directly or indirectly connected to the first imaging apparatus 10 and the second imaging apparatus 12 by a wired method, a wireless method, or the like. Examples of the storage medium include a digital versatile disc (DVD), a universal serial bus (USB) memory, a solid state drive (SSD), a hard disk drive (HDD), and a magnetic tape drive.

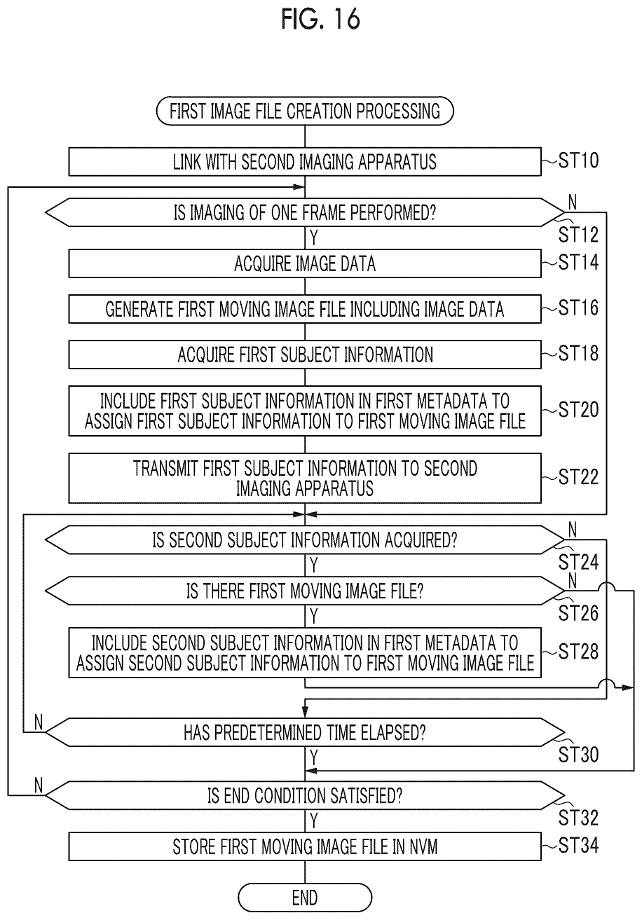

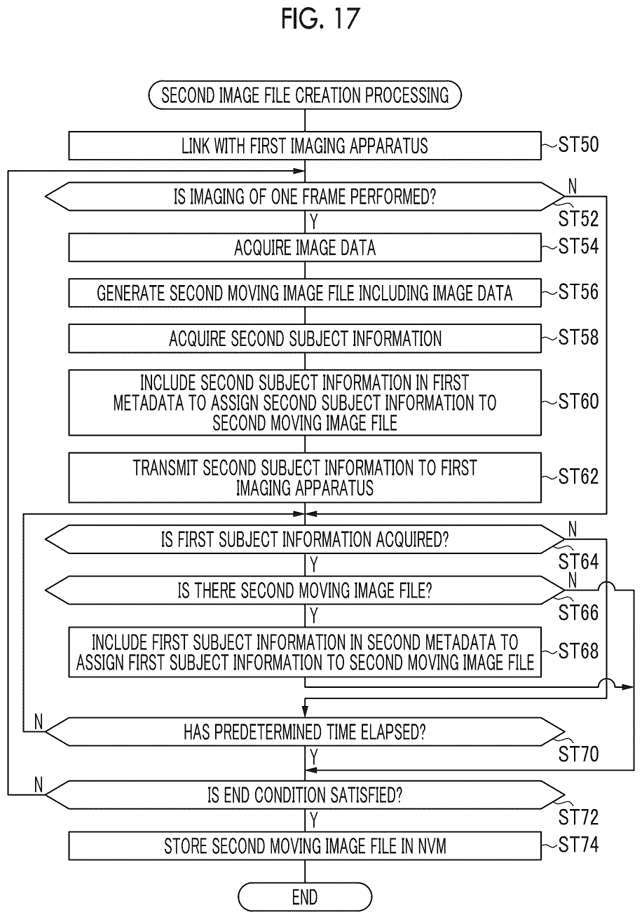

Next, an action of the imaging system 2 will be described with reference to FIGS. 16 and 17. A flow of processing shown in flowcharts of FIG. 16 and FIG. 17 is an example of “imaging processing method” according to the present disclosed technology.

First, an example of a flow of the first image file creation processing performed by the processor 26 in a case where an instruction to start execution of the first image file creation processing in the moving image capturing mode is received by the UI system device 24 of the first imaging apparatus 10 will be described with reference to FIG. 16.

In the first image file creation processing shown in FIG. 16, first, in step ST10, the first linking unit 26A establishes the communication with the second linking unit 44A of the second imaging apparatus 12 via the communication I/Fs 21 and 38 to link the first image file creation processing with the second image file creation processing (refer to FIGS. 4 and 9). The processing of step ST10 is executed, and then the first image file creation processing proceeds to step ST12.

In step ST12, the first generation unit 26B determines whether or not the image sensor 22 performs the imaging of one frame. In step ST12, in a case where the image sensor 22 does not perform the imaging of one frame, a negative determination is made, and the first image file creation processing proceeds to step ST24. In step ST12, in a case where the image sensor 22 performs the imaging of one frame, a positive determination is made, and the first image file creation processing proceeds to step ST14.

In step ST14, the first generation unit 26B acquires the image data 16 from the image sensor 22 (refer to FIG. 4). The processing of step ST14 is executed, and then the first image file creation processing proceeds to step ST16.

In step ST16, the first generation unit 26B generates the first moving image file 56 including the image data 16 acquired in step ST14 (refer to FIG. 4). In a case where the image data 16 acquired in step ST14 is the image data 16 of second and subsequent frames, the first generation unit 26B includes the image data 16, which is acquired in step ST14, in the first moving image file 56 as the image data 16 of one frame to update a content of the first moving image file 56. The processing of step ST16 is executed, and then the first image file creation processing proceeds to step ST18.

In step ST18, the first acquisition unit 26C performs the image recognition processing of the AI type on the image data 16, which is acquired in step ST14, to acquire the first subject information 62 (refer to FIG. 5). The processing of step ST18 is executed, and then the first image file creation processing proceeds to step ST20.

In step ST20, the first assignment unit 26D includes the first subject information 62, which is acquired in step ST18, in the first metadata 60 of the first moving image file 56, which is generated in step ST16, to assign the first subject information 62 to the first moving image file 56 (refer to FIG. 6). The processing of step ST20 is executed, and then the first image file creation processing proceeds to step ST22.

In step ST22, the first assignment unit 26D transmits the same first subject information 62 as the first subject information 62, which is assigned to the first moving image file 56 in step ST20, to the second linking unit 44A of the second imaging apparatus 12 via the first linking unit 26A (refer to FIG. 8). The processing of step ST22 is executed, and then the first image file creation processing proceeds to step ST24.

In step ST24, the first assignment unit 26D determines whether or not the first acquisition unit 26C acquires the second subject information 74 (refer to FIG. 13, FIG. 14, and step ST62 in FIG. 17), which is transmitted from the second linking unit 44A of the second imaging apparatus 12, via the first linking unit 26A. In step ST24, in a case where the first acquisition unit 26C does not acquire the second subject information 74, which is transmitted from the second linking unit 44A of the second imaging apparatus 12, via the first linking unit 26A, a negative determination is made, and the first image file creation processing proceeds to step ST30. In step ST24, in a case where the first acquisition unit 26C acquires the second subject information 74, which is transmitted from the second linking unit 44A of the second imaging apparatus 12, via the first linking unit 26A, a positive determination is made, and the first image file creation processing proceeds to step ST26.

In step ST26, the first assignment unit 26D determines whether or not the first generation unit 26B has already generated the first moving image file 56 in step ST16. In step ST26, in a case where the first generation unit 26B does not generate the first moving image file 56, a negative determination is made, and the first image file creation processing proceeds to step ST32. In step ST26, in a case where the first generation unit 26B has already generated the first moving image file 56, a positive determination is made, and the first image file creation processing proceeds to step ST28.

In step ST28, the first assignment unit 26D includes the second subject information 74, which is acquired in step ST24, in the first metadata 60 to assign the second subject information 74 to the first moving image file 56 (refer to FIG. 14). The processing of step ST28 is executed, and then the first image file creation processing proceeds to step ST32.

In step ST30, the first assignment unit 26D determines whether or not a predetermined time (for example, several seconds) has elapsed since the execution of the processing in step ST24 is started. In step ST30, in a case where the predetermined time has not elapsed since the execution of the processing in step ST24 is started, a negative determination is made, and the first image file creation processing proceeds to step ST24. In step ST30, in a case where a predetermined time has elapsed since the execution of the process in step ST24 is started, a positive determination is made, and the first image file creation processing proceeds to step ST32.

In step ST32, the first control unit 26E determines whether or not a condition under which the first image file creation processing ends (hereinafter referred to as “first image file creation processing end condition”) is satisfied. A first example of the first image file creation processing end condition is a condition that the UI system device 24 receives an instruction to end the first image file creation processing. A second example of the first image file creation processing end condition includes a condition that a data amount of the first moving image data 58 reaches an upper limit value. In step ST32, in a case where the first image file creation processing end condition is not satisfied, a negative determination is made, and the first image file creation processing proceeds to step ST12. In step ST32, in a case where the first image file creation processing end condition is satisfied, a positive determination is made, and the first image file creation processing proceeds to step ST34.

In step ST34, the first control unit 26E stores the first moving image file 56, which is obtained by executing the pieces of processing of steps ST10 to ST32, in the NVM 28 (refer to FIG. 15). The processing of step ST34 is executed, and then the first image file creation processing ends.

FIG. 17 shows an example of a flow of the second image file creation processing performed by the processor 44 in a case where an instruction to start execution of the second image file creation processing in the moving image capturing mode is received by the UI system device 42 of the second imaging apparatus 12.

Here, a difference between the first image file creation processing described with reference to FIG. 16 and the second image file creation processing will be described. First, the first image file creation processing in FIG. 16 is processing that is centered on the first imaging apparatus 10, whereas the second image file creation processing in FIG. 17 is processing that is centered on the second imaging apparatus 12. Accordingly, the first moving image file 56 is created by the first imaging apparatus 10 in FIG. 16, whereas the second moving image file 68 is created by the second imaging apparatus 12 in FIG. 17. Further, in FIG. 16, the first imaging apparatus 10 acquires the first subject information 62 from the image data 16 acquired by the first imaging apparatus 10, and links the first subject information 62 with the second imaging apparatus 12 to acquire the second subject information 74. On the other hand, in FIG. 17, the second imaging apparatus 12 acquires the second subject information 74 from the image data 18 acquired by the second imaging apparatus 12, and links the second subject information 74 with the first imaging apparatus 10 to acquire the first subject information 62.

Except for the above difference, description of each step (ST50, ST52, ST54, and the like) in FIG. 17 and the description of each step (ST10, ST12, ST14, and the like) in FIG. 16 are substantially the same.

As described above, in the imaging system 2, with the establishment of the communication between the first imaging apparatus 10 and the second imaging apparatus 12, the first image file creation processing performed by the first imaging apparatus 10 is linked with the second image file creation processing performed by the second imaging apparatus 12.

In the first imaging apparatus 10, the first subject information 62 is acquired as the information related to the subject 14 (refer to FIG. 5), and the first subject information 62 is included in the first metadata 60 to assign the first subject information 62 to the first moving image file 56 (refer to FIG. 6).

On the other hand, in the second imaging apparatus 12 as well, the second subject information 74 is acquired as the information related to the subject 14 (refer to FIG. 10), and the second subject information 74 is included in the second metadata 72 to assign the second subject information 74 to the second moving image file 68 (refer to FIG. 11).

The second imaging apparatus 12 acquires the same first subject information 62 as the first subject information 62, which is assigned to the first moving image file 56, from the first imaging apparatus 10 (refer to FIG. 12). In the second imaging apparatus 12, the first subject information 62 is included in the second metadata 72 to assign the first subject information 62 to the second moving image file 68 (refer to FIG. 12). Therefore, for example, the user, the apparatus, or the like that performs the processing on the second moving image file 68 can obtain the same first subject information 62 as the first subject information 62, which is the information included in the first moving image file 56, from the second moving image file 68. That is, the user, the apparatus, or the like that performs the processing on the second moving image file 68 can understand what kind of information the first subject information 62, which is included in the first moving image file 56, is (for example, feature included in the subject 14 in a case where the subject 14 is imaged from first imaging apparatus 10 side) without reproducing the first moving image file 56. As a result, convenience of the second moving image file 68 is improved.

On the other hand, the first imaging apparatus 10 acquires the same second subject information 74 as the second subject information 74, which is assigned to the second moving image file 68, from the second imaging apparatus 12 (refer to FIG. 14). In the first imaging apparatus 10, the second subject information 74 is included in the first metadata 60 to assign the second subject information 74 to the first moving image file 56 (refer to FIG. 14). Therefore, for example, the user, the apparatus, or the like that performs the processing on the first moving image file 56 can obtain the same second subject information 74 as the second subject information 74, which is the information included in the second moving image file 68, from the first moving image file 56. That is, the user, the apparatus, or the like that performs the processing on the first moving image file 56 can understand what kind of information the second subject information 74, which is included in the second moving image file 68, is (for example, feature included in the subject 14 in a case where the subject 14 is imaged from second imaging apparatus 12 side) without reproducing the second moving image file 68. As a result, convenience of the first moving image file 56 is improved.

Further, in the imaging system 2, the first imaging apparatus 10 and the second imaging apparatus 12 image the subject 14, which is the common subject. The first metadata 60 of the first moving image file 56 and the second metadata 72 of the second moving image file 68 include the first subject information 62 and the second subject information 74, which are related to the subject 14. Therefore, the user, the apparatus, or the like that performs the processing on the first moving image file 56 can obtain the first subject information 62 and the second subject information 74 related to the subject 14, which is the common subject, from the first moving image file 56. As a result, convenience of the first moving image file 56 is improved. Further, the user, the apparatus, or the like that performs the processing on the second moving image file 68 can obtain the first subject information 62 and the second subject information 74 related to the subject 14, which is the common subject, from the second moving image file 68. As a result, convenience of the second moving image file 68 is improved.

In the above embodiment, the embodiment example has been described in which the first imaging apparatus 10 performs the first image file creation processing and the second imaging apparatus 12 performs the second image file creation processing. However, the present disclosed technology is not limited thereto. For example, the first image file creation processing and the second image file creation processing may be performed in different time slots by the first imaging apparatus 10 or the second imaging apparatus 12. In this case, in the first imaging apparatus 10 or the second imaging apparatus 12, the first subject information 62 and the second subject information 74 can be shared between the first moving image file 56 and the second moving image file 68, which are obtained in the different time slots, and thus usability is improved. Further, the first subject information 62 and the second subject information 74 may be shared after the recording of the first moving image file 56 and the second moving image file 68 is completed.

In the above embodiment, the embodiment example has been described in which the first subject information 62 and the second subject information 74 are generated for each frame and assigned to the first moving image file 56 and the second moving image file 68. However, the present disclosed technology is not limited thereto. For example, the first subject information 62 and the second subject information 74 may be generated and assigned to the first moving image file 56 and the second moving image file 68 in a case where a certain condition is satisfied. An example of the certain condition includes a condition that the UI system device 42 receives a specific instruction, a condition that the imaging is performed within a designated imaging period, a condition that a specific imaging condition is set, a condition that the first imaging apparatus 10 or the second imaging apparatus 12 reaches a specific position, a condition that a distance between the first imaging apparatus 10 and the second imaging apparatus 12 falls within a specific range, a condition that a posture of the first imaging apparatus 10 or the second imaging apparatus 12 is a specific posture, a condition that a certain time has elapsed, a condition that the imaging of a certain number of frames is performed, a condition that the imaging is performed under a designated imaging condition, or a condition that the imaging is performed under a designated environment. Further, for example, the first subject information 62 and the second subject information 74 may be generated for each of two or more predetermined numbers of frames (for example, several frames to several tens of frames) and assigned to the first moving image file 56 and the second moving image file 68. The above description also applies to each modification example to be described below.

In the following, for convenience of description, in a case where there is no need to distinguish between the first subject information 62 and the second subject information 74, the first subject information 62 and the second subject information 74 are referred to as “subject information” without reference numerals. Further, in the following, for convenience of description, in a case where there is no need to distinguish between the first moving image file 56 and the second moving image file 68, the first moving image file 56 and the second moving image file 68 are referred to as “moving image file”. Further, in the following, for convenience of description, in a case where there is no need to distinguish between the first metadata 60 and the second metadata 72, the first metadata 60 and the second metadata 72 are referred to as “metadata” without reference numerals. Further, in the following, for convenience of description, in a case where there is no need to distinguish between the first imaging apparatus 10 and the second imaging apparatus 12, the first imaging apparatus 10 and the second imaging apparatus 12 are referred to as “imaging apparatus” without reference numerals. Further, in the following, for convenience of description, in a case where there is no need to distinguish between the first information processing apparatus 20 and the second information processing apparatus 36, the first information processing apparatus 20 and the second information processing apparatus 36 are referred to as “information processing apparatus” without reference numerals. Further, in the following, for convenience of description, in a case where there is no need to distinguish between the processor 26 and the processor 44, the processor 26 and the processor 44 are referred to as “processor” without reference numerals. Further, in the following, for convenience of description, in a case where there is no need to distinguish between the NVM 28 and the NVM 46, the NVM 28 and the NVM 46 are referred to as “NVM” without reference numerals. Further, in the following, for convenience of description, in a case where there is no need to distinguish between the RAM 30 and the RAM 48, the RAM 30 and the RAM 48 are referred to as “RAM” without reference numerals. Further, in the following, for convenience of description, in a case where there is no need to distinguish between the first image file creation program 52 and the second image file creation program 54, the first image file creation program 52 and the second image file creation program 54 are referred to as “image file creation program” without reference numerals. Further, in the following, for convenience of description, in a case where there is no need to distinguish between the first image file creation processing and the second image file creation processing, the first image file creation processing and the second image file creation processing will be referred to as “image file creation processing” without reference numerals.

### First Modification Example

In the above embodiment, the embodiment example has been described in which the metadata of the moving image file includes the first subject information 62 and the second subject information 74, but the present disclosed technology is not limited thereto. For example, the first metadata 60 and the second metadata 72, which are recorded in the moving image file, may have information in common with each other.

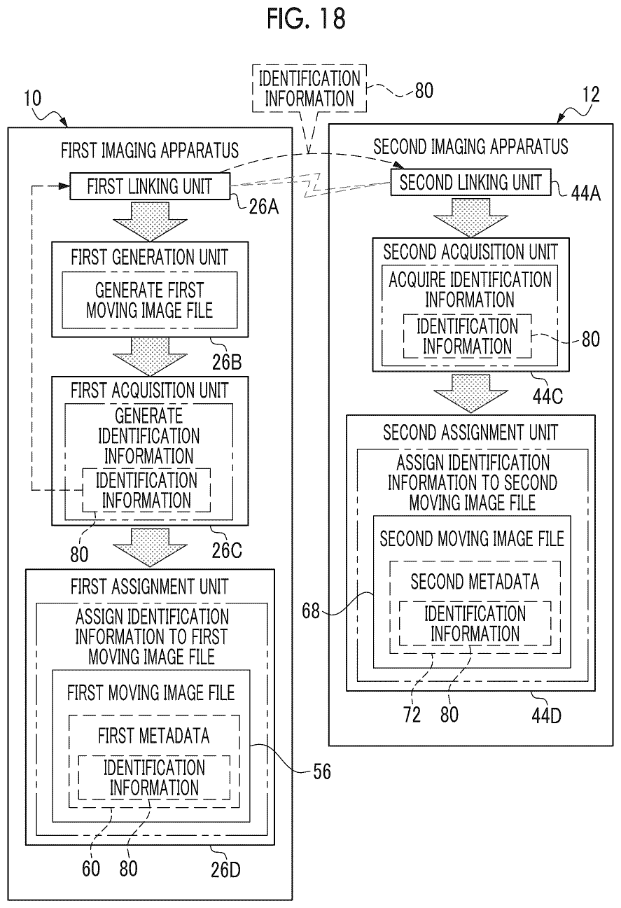

In this case, for example, as shown in FIG. 18, in the first imaging apparatus 10, the first acquisition unit 26C generates identification information 80 on a condition that the first generation unit 26B generates the first moving image file 56. The identification information 80 is information (for example, code) common to the first metadata 60 and the second metadata 72. The first assignment unit 26D includes the identification information 80, which is generated by the first acquisition unit 26C, in the first metadata 60 in the same manner as the first subject information 62 to assign the identification information 80 to the first moving image file 56. Further, the first acquisition unit 26C transmits the identification information 80 to the second imaging apparatus 12 via the first linking unit 26A, in the same manner as the first subject information 62.

In the second imaging apparatus 12, the second acquisition unit 44C acquires the identification information 80, which is transmitted from the first imaging apparatus 10, via the second linking unit 44A. The second assignment unit 44D includes the identification information 80, which is acquired by the second acquisition unit 44C, in the second metadata 72 in the same manner as the first subject information 62 to assign the identification information 80 to the second moving image file 68.

Accordingly, since the identification information 80, which is the common information for the first metadata 60 and the second metadata 72, is included in both of the first metadata 60 and the second metadata 72, the user, the apparatus, or the like that performs the processing on the moving image file can specify which moving image file of the plurality of moving files is related.

Further, the identification information 80 may be generated in a case where a specific condition is satisfied. The case where the specific condition is satisfied refers to, for example, a case where the UI system device 42 receives a specific instruction, a case where the imaging is performed within a designated imaging period, a case where a specific imaging condition is set for the imaging apparatus, a case where the imaging apparatus reaches a specific position, a case where a distance between the first imaging apparatus 10 and the second imaging apparatus 12 falls within a specific range, a case where a posture of the imaging apparatus is a specific posture, a case where a certain time has elapsed, a case where the imaging of a certain number of frames is performed, a case where the imaging is performed under a designated imaging condition, or a case where the imaging is performed under a designated environment.

For example, the identification information 80, which is generated in a case where the specific condition is satisfied, is included in the frame-related data 60B corresponding to the image data 16 obtained at a timing corresponding to a timing at which the identification information 80 is generated. The frame-related data 72B of the second moving image file 68 also includes the identification information 80 in the same manner as the first subject information 62. Accordingly, the user, the apparatus, or the like that performs the processing on the moving image file can specify information having a high relevance (for example, information obtained in a case where the specific condition is satisfied) between the frame of the first moving image file 56 and the frame of the second moving image file 68.

In the example shown in FIG. 18, the embodiment example has been described in which the identification information 80 is generated in the first imaging apparatus 10 and provided to the second imaging apparatus 12, but this is merely an example. The identification information 80 may be generated in the second imaging apparatus 12 and provided to the first imaging apparatus 10. Further, the identification information 80 may be assigned to the first imaging apparatus 10 and the second imaging apparatus 12 from the outside (for example, user or apparatus).

### Second Modification Example

In the first modification example, the embodiment example has been described in which the first metadata 60 and the second metadata 72 of the moving image file include the identification information 80, but the present disclosed technology is not limited thereto. For example, the first metadata 60 and the second metadata 72 of the moving image file may include time information related to the frame.

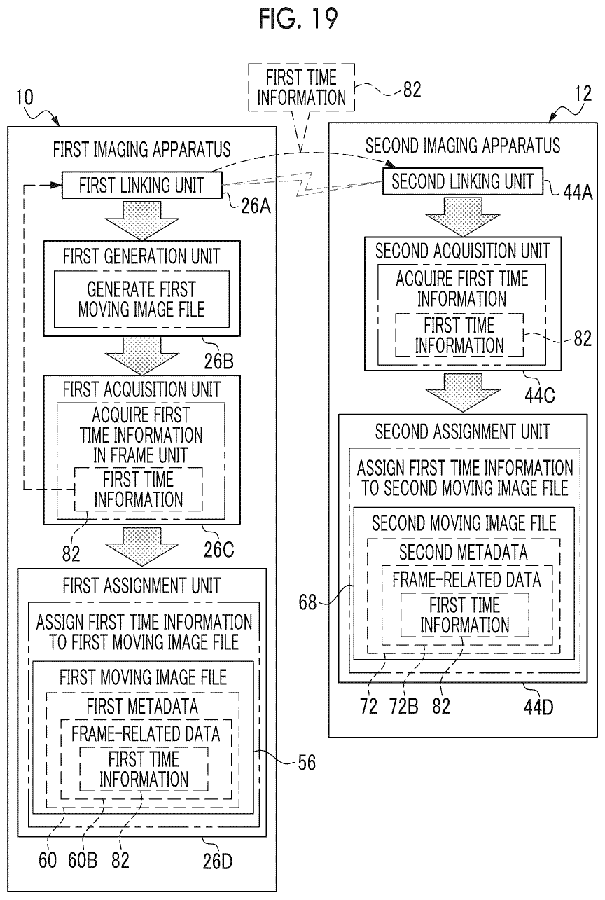

In this case, for example, as shown in FIG. 19, in the first imaging apparatus 10, the first acquisition unit 26C acquires first time information 82 in a frame unit (that is, each time imaging of one frame is performed). The first time information 82 indicates, for example, a time point (for example, time point corresponding to imaging time point) at which the image data 16, which is obtained by performing the imaging of one frame by the image sensor 22, is acquired by the first generation unit 26B. Here, the time point is exemplified, but this is merely an example. An identifier that can specify, in time series, a frame obtained after the imaging is started or an elapsed time from the start of the imaging may be employed.

The first assignment unit 26D includes the first time information 82, which is generated by the first acquisition unit 26C, in the corresponding frame-related data 60B in the same manner as the first subject information 62 to assign the first time information 82 to the first moving image file 56. Accordingly, the frame-related data 60B of the first moving image file 56 includes the first time information 82. Therefore, the user, the apparatus, or the like that performs the processing on the first moving image file 56 can specify, from the first moving image file 56, information corresponding to the image data 16 obtained at a specific timing.

On the other hand, the first acquisition unit 26C transmits the first time information 82 to the second imaging apparatus 12 via the first linking unit 26A, in the same manner as the first subject information 62.

In the second imaging apparatus 12, the second acquisition unit 44C acquires the first time information 82, which is transmitted from the first imaging apparatus 10, via the second linking unit 44A. The second assignment unit 44D includes the first time information 82, which is acquired by the second acquisition unit 44C, in the frame-related data 72B in the same manner as the first subject information 62 to assign the first time information 82 to the second moving image file 68. Accordingly, the frame-related data 72B of the second moving image file 68 includes the first time information 82. Therefore, the user, the apparatus, or the like that performs the processing on the second moving image file 68 can specify, from the second moving image file 68, information corresponding to the image data 16 obtained at the specific timing.

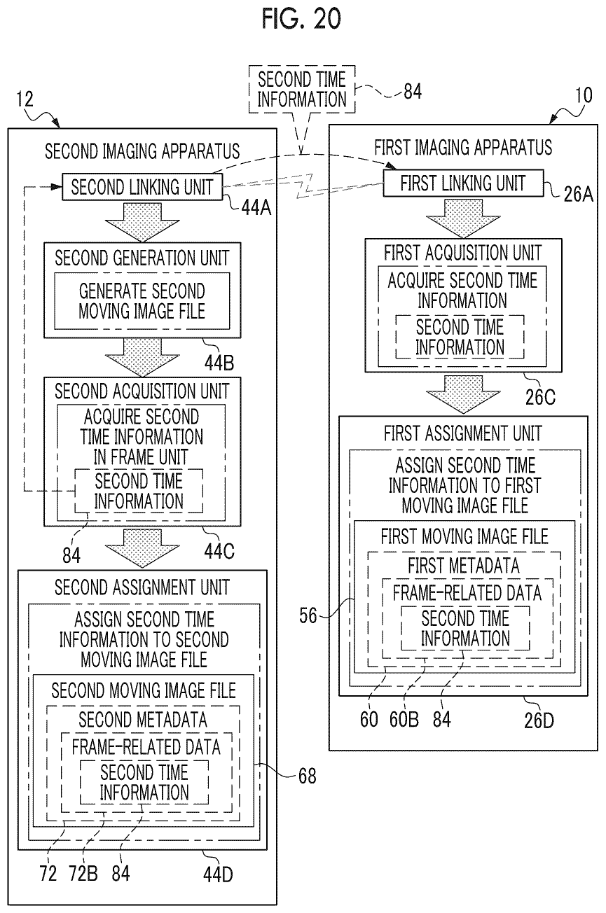

As shown in FIG. 20 as an example, in the second imaging apparatus 12, the second acquisition unit 44C acquires second time information 84 in a frame unit (that is, each time imaging of one frame is performed). The second time information 84 indicates, for example, a time point (for example, point in time corresponding to imaging time point) at which the image data 18, which is obtained by performing the imaging of one frame by the image sensor 40, is acquired by the second generation unit 44B. Accordingly, it is possible to easily specify the image data 16 (frame) of the first moving image file 56 and the image data 18 (frame) of the second moving image file 68, which are obtained by being imaged at the same time point. Here, the time point is exemplified, but this is merely an example. An identifier that can specify, in time series, a frame obtained after the imaging is started or an elapsed time from the start of the imaging may be employed.

The second assignment unit 44D includes the second time information 84, which is generated by the second acquisition unit 44C, in the corresponding frame-related data 72B in the same manner as the second subject information 74 to assign the second time information 84 to the second moving image file 68. Accordingly, the frame-related data 72B of the second moving image file 68 includes the second time information 84. Therefore, the user, the apparatus, or the like that performs the processing on the second moving image file 68 can specify, from the second moving image file 68, information corresponding to the image data 18 obtained at the specific timing.

On the other hand, the second acquisition unit 44C transmits the second time information 84 to the second imaging apparatus 12 via the first linking unit 26A, in the same manner as the second subject information 74.

In the first imaging apparatus 10, the first acquisition unit 26C acquires the second time information 84, which is transmitted from the second imaging apparatus 12, via the first linking unit 26A. The first assignment unit 26D includes the second time information 84, which is acquired by the first acquisition unit 26C, in the frame-related data 60B in the same manner as the second subject information 74 to assign the second time information 84 to the first moving image file 56. Accordingly, the frame-related data 60B of the first moving image file 56 includes the second time information 84. Therefore, the user, the apparatus, or the like that performs the processing on the first moving image file 56 can specify, from the first moving image file 56, information corresponding to the image data 18 obtained at the specific timing.

### Third Modification Example

In the second modification example, the embodiment example has been described in which the first metadata 60 and the second metadata 72 of the moving image file include the first time information 82 and the second time information 84, but the present disclosed technology is not limited thereto. For example, the first metadata 60 and the second metadata 72 of the moving image file may include information related to the imaging apparatus.

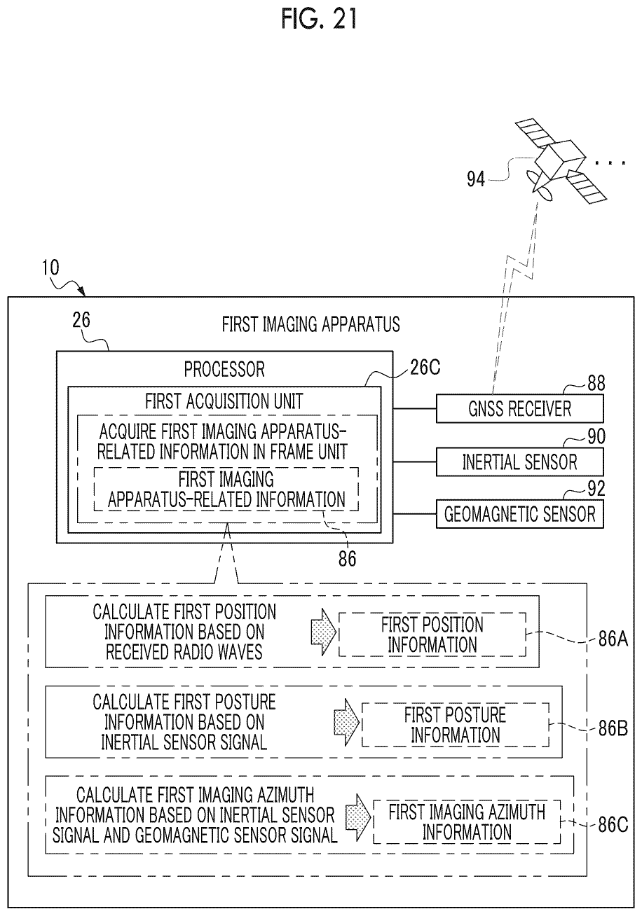

In this case, for example, as shown in FIG. 21, the first acquisition unit 26C acquires first imaging apparatus-related information 86 in a frame unit (that is, for each piece of image data 16) obtained by imaging the subject 14 with the image sensor 22. The first imaging apparatus-related information 86 relates to the first imaging apparatus 10. Examples of the first imaging apparatus-related information 86 include first position information 86A, first posture information 86B, and first imaging azimuth information 86C. The first position information 86A relates to a position of the first imaging apparatus 10. The first posture information 86B relates to a posture of the first imaging apparatus 10. The first imaging azimuth information 86C is information in which an imaging direction (that is, orientation of optical axis) of the first imaging apparatus 10 is expressed by an azimuth.

The first imaging apparatus-related information 86 is an example of “information related to first imaging apparatus” according to the present disclosed technology. The first position information 86A is an example of “first position information” according to the present disclosed technology. The first posture information 86B is an example of “first posture information” according to the present disclosed technology. The first imaging azimuth information 86C is an example of “first direction information” according to the present disclosed technology.

The first imaging apparatus 10 is provided with a global navigation satellite system (GNSS) receiver 88, an inertial sensor 90, and a geomagnetic sensor 92. The GNSS receiver 88, the inertial sensor 90, and the geomagnetic sensor 92 are connected to the processor 26. The GNSS receiver 88 receives radio waves transmitted from a plurality of satellites 94. The inertial sensor 90 measures physical quantities (for example, angular velocity and acceleration) indicating a three-dimensional inertial movement of the first imaging apparatus 10 and outputs an inertial sensor signal indicating a measurement result. The geomagnetic sensor 92 detects geomagnetism and outputs a geomagnetic sensor signal indicating a detection result.

The first acquisition unit 26C calculates, as the first position information 86A, a latitude, a longitude, and an altitude that can specify a current position of the first imaging apparatus 10 based on the radio waves received by the GNSS receiver 88. Further, the first acquisition unit 26C calculates the first posture information 86B (for example, information defined by yaw angle, roll angle, and pitch angle) based on the inertial sensor signal input from the inertial sensor 90. Further, the first acquisition unit 26C calculates the first imaging azimuth information 86C based on the inertial sensor signal input from the inertial sensor 90 and the geomagnetic sensor signal input from the geomagnetic sensor 92. Further, the first acquisition unit 26C calculates an imaging posture (whether long side direction of camera faces vertically or horizontally) of the first imaging apparatus 10 from the information of the inertial sensor 90.

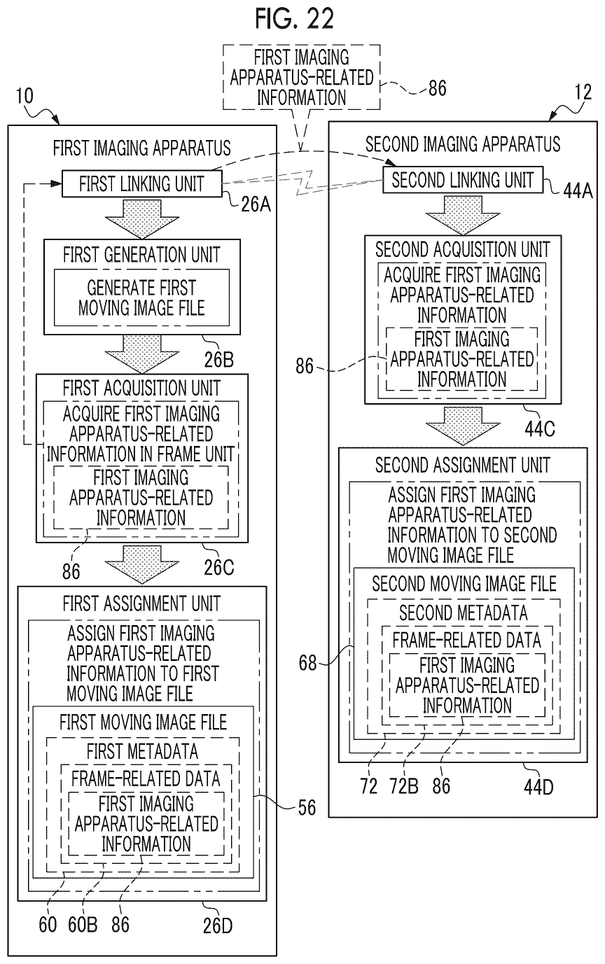

As shown in FIG. 22 as an example, in the first imaging apparatus 10, the first acquisition unit 26C acquires the first imaging apparatus-related information 86 in a frame unit (that is, each time imaging of one frame is performed).

The first assignment unit 26D includes the first imaging apparatus-related information 86, which is generated by the first acquisition unit 26C, in the corresponding frame-related data 60B in the same manner as the first subject information 62 to assign the first imaging apparatus-related information 86 to the first moving image file 56. Accordingly, the frame-related data 60B of the first moving image file 56 includes the first imaging apparatus-related information 86. Therefore, the user, the apparatus, or the like that performs the processing on the first moving image file 56 can specify, from the first moving image file 56, the information related to the first imaging apparatus 10 (here, as an example, position of first imaging apparatus 10, imaging posture of first imaging apparatus 10, and imaging direction of first imaging apparatus 10).

On the other hand, the first acquisition unit 26C transmits the first imaging apparatus-related information 86 to the second imaging apparatus 12 via the first linking unit 26A, in the same manner as the first subject information 62.

In the second imaging apparatus 12, the second acquisition unit 44C acquires the first imaging apparatus-related information 86, which is transmitted from the first imaging apparatus 10, via the second linking unit 44A. The second assignment unit 44D includes the first imaging apparatus-related information 86, which is acquired by the second acquisition unit 44C, in the frame-related data 72B in the same manner as the first subject information 62 to assign the first imaging apparatus-related information 86 to the second moving image file 68. Accordingly, since the frame-related data 72B of the second moving image file 68 includes the first imaging apparatus-related information 86, the user, the apparatus, or the like that performs the processing on the second moving image file 68 can specify, from the second moving image file 68, the information related to the first imaging apparatus 10 (here, as an example, position of first imaging apparatus 10, imaging posture of first imaging apparatus 10, and imaging direction of first imaging apparatus 10).

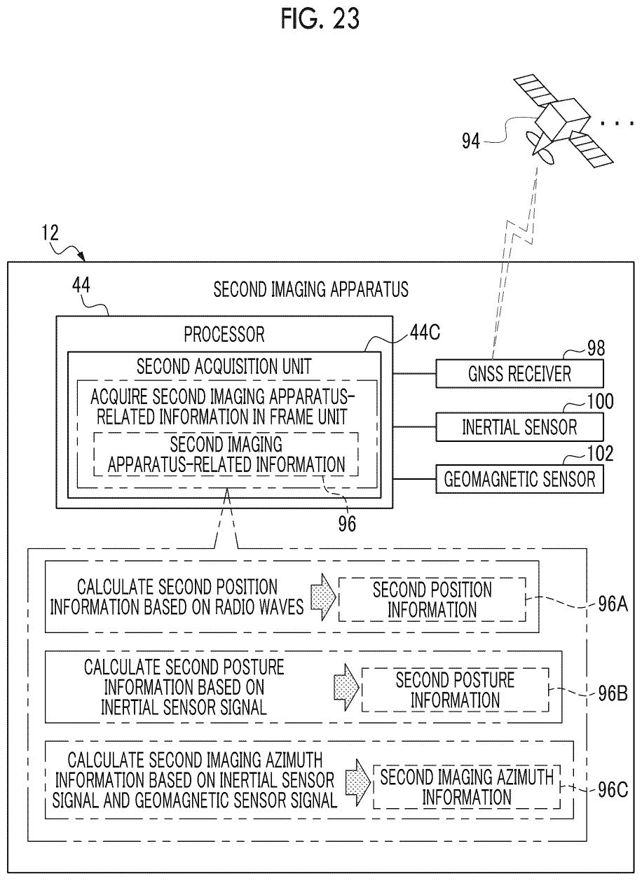

As shown in FIG. 23 as an example, the second acquisition unit 44C acquires second imaging apparatus-related information 96 in a frame unit (that is, for each piece of image data 18) obtained by imaging the subject 14 with the image sensor 40. The second imaging apparatus-related information 96 relates to the second imaging apparatus 12. The second imaging apparatus-related information 96 is an example of “information related to second imaging apparatus” according to the present disclosed technology.

Examples of the second imaging apparatus-related information 96 include second position information 96A, second posture information 96B, and second imaging azimuth information 96C. The second position information 96A relates to a position of the second imaging apparatus 12. The second posture information 96B relates to a posture of the second imaging apparatus 12. The second imaging azimuth information 96C is information in which the imaging direction (that is, orientation of optical axis) of the second imaging apparatus 12 is expressed by the azimuth.

The second imaging apparatus 12 is provided with a GNSS receiver 98 similar to the GNSS receiver 88, an inertial sensor 100 similar to the inertial sensor 90, and a geomagnetic sensor 102 similar to the geomagnetic sensor 92.

The second acquisition unit 44C calculates, as the second position information 96A, a latitude, a longitude, and an altitude that can specify a current position of the second imaging apparatus 12 based on the radio waves received by the GNSS receiver 98. Further, the second acquisition unit 44C calculates the second posture information 96B (for example, information defined by yaw angle, roll angle, and pitch angle) based on the inertial sensor signal input from the inertial sensor 100. Further, the second acquisition unit 44C calculates the second imaging azimuth information 96C based on the inertial sensor signal input from the inertial sensor 100 and the geomagnetic sensor signal input from the geomagnetic sensor 102.

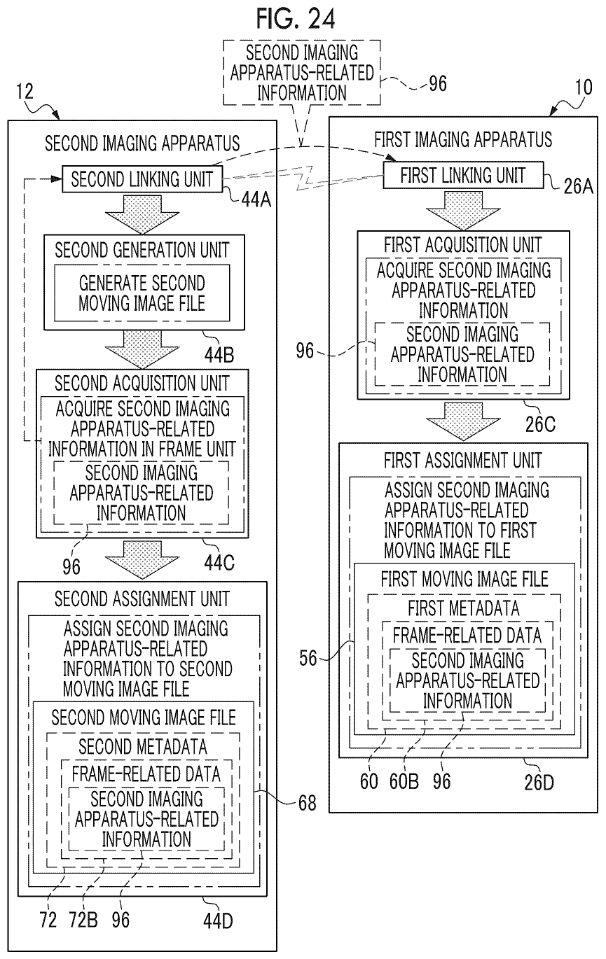

As shown in FIG. 24 as an example, in the first imaging apparatus 10, the first acquisition unit 26C acquires the second imaging apparatus-related information 96 in a frame unit (that is, each time imaging of one frame is performed).

The second assignment unit 44D includes the second imaging apparatus-related information 96, which is generated by the second acquisition unit 44C, in the corresponding frame-related data 72B in the same manner as the second subject information 74 to assign the second imaging apparatus-related information 96 to the second moving image file 68. Accordingly, since the frame-related data 72B of the second moving image file 68 includes the second imaging apparatus-related information 96, the user, the apparatus, or the like that performs the processing on the second moving image file 68 can specify, from the second moving image file 68, the information related to the second imaging apparatus 12 (here, as an example, position of second imaging apparatus 12, imaging posture of second imaging apparatus 12, and imaging direction of second imaging apparatus 12).

On the other hand, the second acquisition unit 44C transmits the second imaging apparatus-related information 96 to the first imaging apparatus 10 via the second linking unit 44A, in the same manner as the second subject information 74.

In the first imaging apparatus 10, the first acquisition unit 26C acquires the second imaging apparatus-related information 96, which is transmitted from the second imaging apparatus 12, via the first linking unit 26A. The first assignment unit 26D includes the second imaging apparatus-related information 96, which is acquired by the first acquisition unit 26C, in the frame-related data 60B in the same manner as the second subject information 74 to assign the second imaging apparatus-related information 96 to the first moving image file 56. Accordingly, since the frame-related data 60B of the first moving image file 56 includes the second imaging apparatus-related information 96, the user, the apparatus, or the like that performs the processing on the first moving image file 56 can specify, from the first moving image file 56, the information related to the second imaging apparatus 12 (here, as an example, position of second imaging apparatus 12, imaging posture of second imaging apparatus 12, and imaging direction of second imaging apparatus 12).

In the present third modification example, since the first imaging apparatus 10 includes the second imaging apparatus-related information 96 in addition to the first imaging apparatus-related information 86, it is possible to specify a relationship of position or the like between the subject imaged by the first imaging apparatus 10 and the subject imaged by the second imaging apparatus 12. Accordingly, it is possible to determine whether or not the first subject information 62 acquired by the imaging performed by the first imaging apparatus 10 and the second subject information 74 obtained by the linking with the second imaging apparatus 12 are information related to the common subject.

In the third modification example, the first position information 86A, the first posture information 86B, and the first imaging azimuth information 86C are exemplified as the first imaging apparatus-related information 86, and the second position information 96A, the second posture information 96B, and the second imaging azimuth information 96C are exemplified as the second imaging apparatus-related information 96. However, the present disclosed technology is not limited thereto. For example, the first imaging apparatus-related information 86 and the second imaging apparatus-related information 96 may include distance information. The distance information indicates a distance between the first imaging apparatus 10 and the second imaging apparatus 12. The distance information is calculated using, for example, the first position information 86A and the second position information 96A. Further, the distance information may indicate a distance (that is, distance between the first imaging apparatus 10 and the second imaging apparatus 12) obtained by performing distance measurement using a phase difference pixel, laser distance measurement, or the like between the first imaging apparatus 10 and the second imaging apparatus 12. As described above, since the first imaging apparatus-related information 86 and the second imaging apparatus-related information 96 include the distance information, the user, the apparatus, or the like that performs the processing on the moving image file can specify, from the moving image file, the distance between the first imaging apparatus 10 and the second imaging apparatus 12.

Further, the first imaging azimuth information 86C or the second imaging azimuth information 96C may include information indicating an orientation (for example, azimuth) from one of the first imaging apparatus 10 and the second imaging apparatus 12 to the other.

Further, in the present third modification example, the embodiment example has been described in which the processor calculates the first position information 86A and the second position information 96A by using the GNSS, but this is merely an example. For example, information specified from a position designated in map data by the user or the like (for example, latitude, longitude, and altitude) may be used as the first position information 86A or the second position information 96A.

Further, the first position information 86A and the second position information 96A may not be the information defined by the latitude, the longitude, and the altitude. The first position information 86A or the second position information 96A may be information defined by the latitude and the longitude or may be information defined by two-dimensional coordinates or three-dimensional coordinates.

In a case where the first position information 86A or the second position information 96A is defined by the two-dimensional coordinates or the three-dimensional coordinates, for example, the current position of the imaging apparatus in a two-dimensional plane or a three-dimensional space applied to a real space with the position designated by the user or the like as the origin is defined by the two-dimensional coordinates or the three-dimensional coordinates. In this case, the current position of the imaging apparatus is calculated based on, for example, the inertial sensor signal and the geomagnetic sensor signal.

Further, in the present third modification example, the information defined by the yaw angle, the roll angle, and the pitch angle is described as the first posture information 86B and the second posture information 96B, but this is merely an example. Information indicating the posture specified from the yaw angle, the roll angle, and the pitch angle, among a plurality of postures (for example, upward, downward, oblique downward, and oblique upward) of the imaging apparatus, may be used as the first posture information 86B or the second posture information 96B.

### Fourth Modification Example

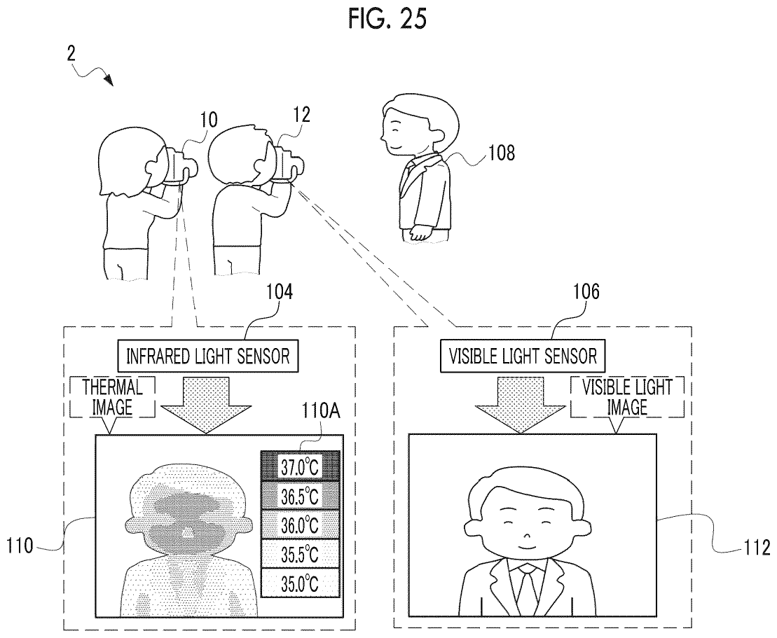

In the above example, the embodiment example has been described in which the first imaging apparatus 10 comprises the image sensor 22 and the second imaging apparatus 12 comprises the image sensor 40. However, in a fourth modification example, as shown in FIG. 25 as an example, an embodiment example will be described in which the first imaging apparatus 10 comprises an infrared light sensor 104 and the second imaging apparatus 12 comprises a visible light sensor 106.

In the example shown in FIG. 25, an aspect is shown in which a person subject 108, which is an example of “subject” according to the present disclosed technology, is imaged from substantially the same direction by the first imaging apparatus 10 and the second imaging apparatus 12. The infrared light sensor 104 provided in the first imaging apparatus 10 is a sensor that images light in a wavelength range higher than a wavelength range of visible light (here, infrared light), and the visible light sensor 106 provided in the second imaging apparatus 12 is a sensor that images the visible light.

A signal output from the infrared light sensor 104 and a signal output from the visible light sensor 106 have different types from each other. That is, the signal output from the infrared light sensor 104 is a signal obtained by imaging the infrared light, and the signal output from the visible light sensor 106 is a signal obtained by imaging the visible light.

The first imaging apparatus 10 images the person subject 108 using the infrared light sensor 104 to generate thermal image data 110 indicating a thermal image. Further, the first imaging apparatus 10 also generates a legend 110A indicating a standard of a temperature distribution in the thermal image data 110. The legend 110A is associated with the thermal image data 110. The second imaging apparatus 12 images the person subject 108 using the visible light sensor 106 to generate visible light image data 112 indicating a visible light image.

The infrared light sensor 104 is an example of “first sensor” according to the present disclosed technology. The visible light sensor 106 is an example of “second sensor” according to the present disclosed technology. The thermal image data 110 is an example of “first output result” and “invisible light image data” according to the present disclosed technology. The visible light image data 112 is an example of “second output result” and “visible light image data” according to the present disclosed technology.

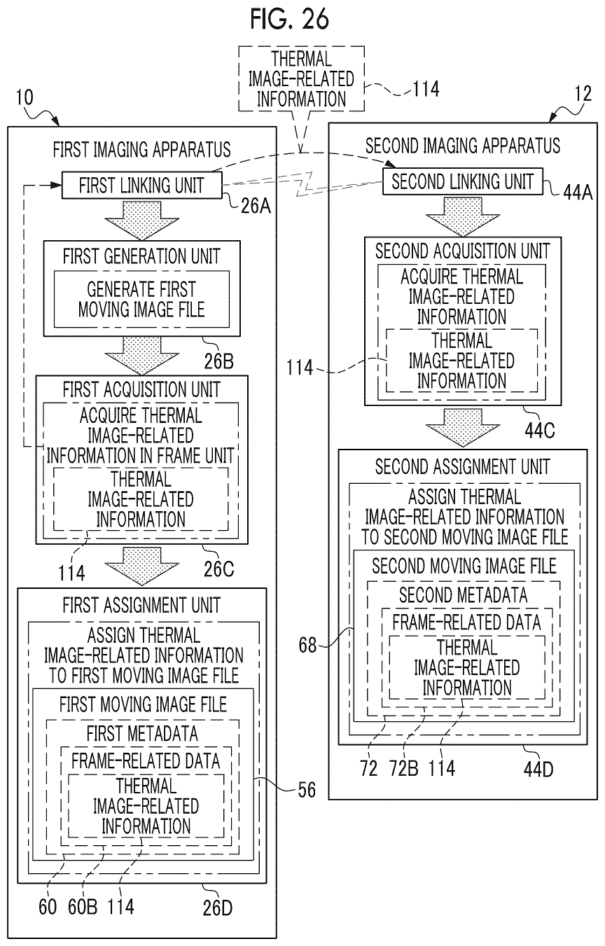

As shown in FIG. 26 as an example, in the first imaging apparatus 10, the first acquisition unit 26C acquires thermal image-related information 114 in a frame unit (that is, each time imaging of one frame is performed). The thermal image-related information 114 relates to the thermal image data 110. An example of the thermal image-related information 114 includes information including designated temperature range data and the like. Predetermined temperature range data indicates an image region in the thermal image data 110 in the designated temperature range (for example, 37° C. or higher). The thermal image-related information 114 may include text information on a temperature and the legend 110A. Further, the thermal image-related information 114 may include data obtained by reducing the thermal image data 110.

The first assignment unit 26D includes the thermal image-related information 114, which is generated by the first acquisition unit 26C, in the corresponding frame-related data 60B in the same manner as the first subject information 62 to assign the thermal image-related information 114 to the first moving image file 56. Accordingly, since the frame-related data 60B of the first moving image file 56 includes the thermal image-related information 114, the user, the apparatus, or the like that performs the processing on the first moving image file 56 can specify, from the first moving image file 56, the information related to the thermal image data 110.

On the other hand, the first acquisition unit 26C transmits the thermal image-related information 114 to the second imaging apparatus 12 via the first linking unit 26A, in the same manner as the first subject information 62.

In the second imaging apparatus 12, the second acquisition unit 44C acquires the thermal image-related information 114, which is transmitted from the first imaging apparatus 10, via the second linking unit 44A. The second assignment unit 44D includes the thermal image-related information 114, which is acquired by the second acquisition unit 44C, in the frame-related data 72B in the same manner as the first subject information 62 to assign the thermal image-related information 114 to the second moving image file 68. Accordingly, since the frame-related data 72B of the second moving image file 68 includes the thermal image-related information 114, the user, the apparatus, or the like that performs the processing on the second moving image file 68 can specify, from the second moving image file 68, the information related to the thermal image data 110. Therefore, the user who has obtained the second moving image file 68 can refer to the visible light image data 112 and the thermal image-related information 114 only with the second moving image file 68. Further, the user, the apparatus, or the like can create, for example, a composite image to which information related to the thermal image data 110 is added to the visible light image indicated by the visible light image data 112, which is included in the second moving image file 68.

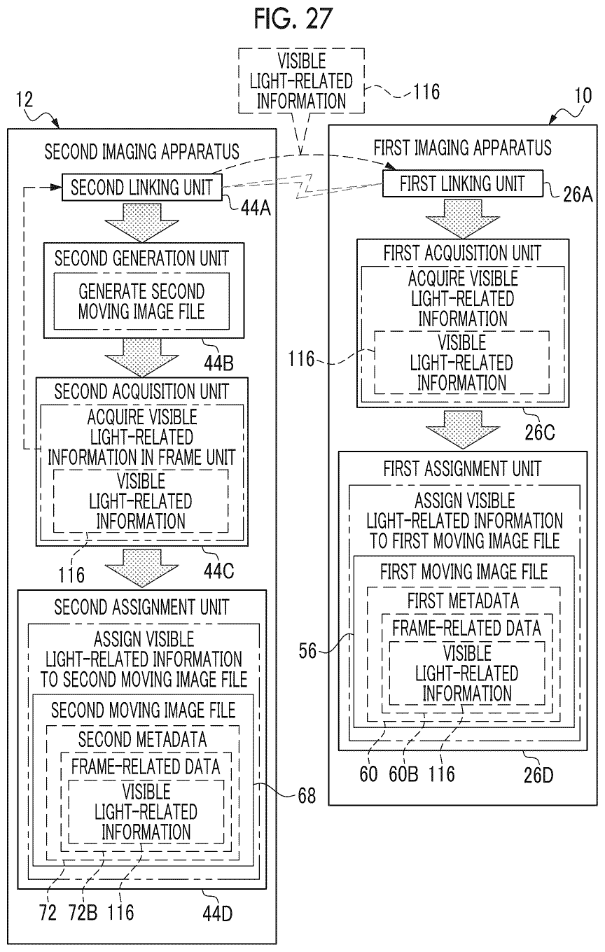

As shown in FIG. 27 as an example, in the second imaging apparatus 12, the second acquisition unit 44C acquires visible light-related information 116 in a frame unit (that is, each time imaging of one frame is performed). The visible light-related information 116 relates to the visible light image data 112. Examples of the visible light-related information 116 include information corresponding to the type or attribute information of the subject, such as age, gender, and facial expression, and data obtained by reducing the visible light image data 112 (for example, thumbnail image data).

The second assignment unit 44D includes the visible light-related information 116, which is generated by the second acquisition unit 44C, in the corresponding frame-related data 72B in the same manner as the second subject information 74 to assign the visible light-related information 116 to the second moving image file 68. Accordingly, since the frame-related data 72B of the second moving image file 68 includes the visible light-related information 116, the user, the apparatus, or the like that performs the processing on the second moving image file 68 can specify, from the second moving image file 68, the information related to the visible light image data 112.

On the other hand, the second acquisition unit 44C transmits the visible light-related information 116 to the first imaging apparatus 10 via the second linking unit 44A, in the same manner as the second subject information 74.

In the first imaging apparatus 10, the first acquisition unit 26C acquires the visible light-related information 116, which is transmitted from the first imaging apparatus 10, via the first linking unit 26A. The first assignment unit 26D includes the visible light-related information 116, which is acquired by the first acquisition unit 26C, in the frame-related data 60B in the same manner as the second subject information 74 to assign the visible light-related information 116 to the first moving image file 56. Accordingly, since the frame-related data 60B of the first moving image file 56 includes the visible light-related information 116, the user, the apparatus, or the like that performs the processing on the first moving image file 56 can specify, from the first moving image file 56, the information related to the visible light image data 112. Therefore, the user who has obtained the first moving image file 56 can refer to the thermal image data 110 and the visible light-related information 116 only with the first moving image file 56. Further, the user, the apparatus, or the like can create, for example, a composite image to which information related to the visible light-related information 116 is added to the thermal image indicated by the thermal image data 110, which is included in the first moving image file 56.

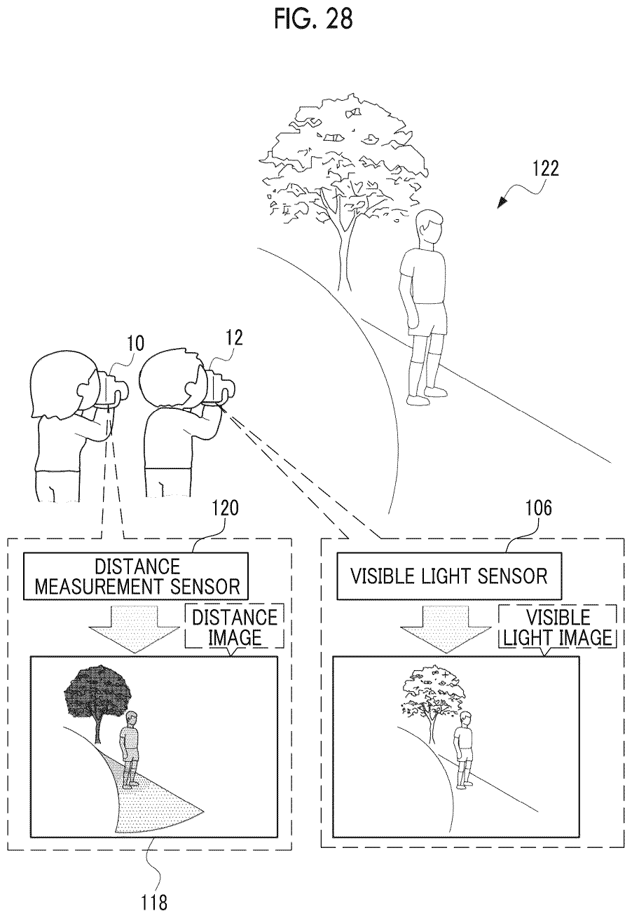

In the example shown in FIG. 25, the thermal image data 110 is shown, but this is merely an example. For example, as shown in FIG. 28, distance image data 118 indicating a distance image may be used instead of the thermal image data 110. In this case, the first imaging apparatus 10 is provided with a distance measurement sensor 120, and the distance measurement sensor 120 measures a distance to a subject 122. The distance measurement sensor 120 comprises a plurality of two-dimensionally arranged infrared rays (IR) pixels, and each of the plurality of IR pixels receives IR reflected light from the subject 122 to perform the distance measurement for each IR pixel. A distance measurement result for each IR pixel is the distance image. The distance image refers to an image in which a distance to a distance measurement target, which is measured for each IR pixel, is expressed in color and/or in gradation.

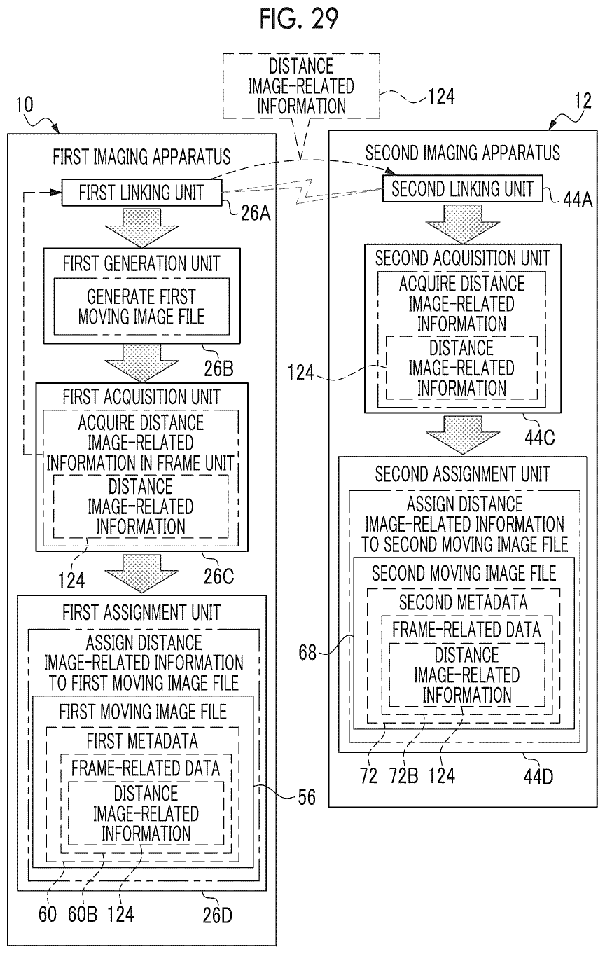

As described above, in a case where the distance image data 118 is used instead of the thermal image data 110, as shown in FIG. 29 as an example, in the first imaging apparatus 10, the first acquisition unit 26C acquires distance image-related information 124 in a frame unit (that is, each time imaging of one frame is performed). The distance image-related information 124 relates to the distance image data 118. An example of the distance image-related information 124 includes data indicating one or more designated image regions in the distance image data 118. Further, the distance image-related information 124 may include image data (for example, thumbnail image data) obtained by reducing the distance image data 118.

The first assignment unit 26D includes the distance image-related information 124, which is generated by the first acquisition unit 26C, in the corresponding frame-related data 60B in the same manner as the first subject information 62 to assign the distance image-related information 124 to the first moving image file 56. Accordingly, since the frame-related data 60B of the first moving image file 56 includes the distance image-related information 124, the user, the apparatus, or the like that performs the processing on the first moving image file 56 can specify, from the first moving image file 56, the information related to the distance image data 118.

On the other hand, the first acquisition unit 26C transmits the distance image-related information 124 to the second imaging apparatus 12 via the first linking unit 26A, in the same manner as the first subject information 62.

In the second imaging apparatus 12, the second acquisition unit 44C acquires the distance image-related information 124, which is transmitted from the first imaging apparatus 10, via the second linking unit 44A. The second assignment unit 44D includes the distance image-related information 124, which is acquired by the second acquisition unit 44C, in the frame-related data 72B in the same manner as the first subject information 62 to assign the distance image-related information 124 to the second moving image file 68. Accordingly, since the frame-related data 72B of the second moving image file 68 includes the distance image-related information 124, the user, the apparatus, or the like that performs the processing on the second moving image file 68 can specify, from the second moving image file 68, the information related to the distance image data 118. Therefore, the user who has obtained the second moving image file 68 can refer to the distance image data 118 and the visible light data only with the second moving image file 68. Further, the user, the apparatus, or the like can create, for example, a composite image to which information related to the distance image data 118 is added to the visible light image indicated by the visible light image data 112, which is included in the second moving image file 68.

In the present fourth modification example, the embodiment example has been described in which the infrared light sensor 104 images the person subject 108, but the present disclosed technology is not limited thereto. For example, even in a case where a subject 198 is imaged in a wavelength range lower than the visible light, the present disclosed technology is established.

### Other Modification Examples

In the above embodiment, the embodiment example has been described in which the first imaging apparatus 10 and the second imaging apparatus 12 image the subject 14, which is the common subject. However, the first imaging apparatus 10 and the second imaging apparatus 12 may image different subjects. In this case, it is possible to specify information about one of the different subjects and information about the other of the different subjects from one moving image file (for example, the first moving image file 56 or the second moving image file 68).

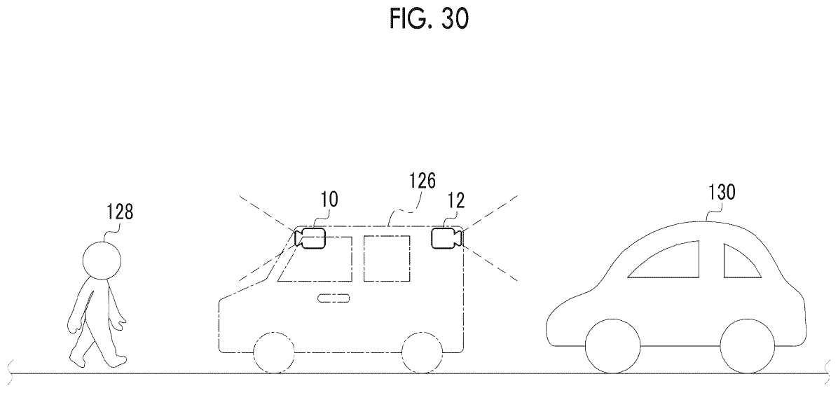

As a scene in which the first imaging apparatus 10 and the second imaging apparatus 12 image the different subjects, a scene is considered in which the first imaging apparatus 10 and the second imaging apparatus 12 are used as a part of a drive recorder mounted on a vehicle. For example, as shown in FIG. 30, the first imaging apparatus 10 is attached to a vehicle 126 as a front camera mounted on a two-camera type drive recorder, and the second imaging apparatus 12 is attached to the vehicle 126 as a rear camera. The first imaging apparatus 10 images a subject 128 (person in the example shown in FIG. 30) at a front of the vehicle, and the second imaging apparatus 12 images a subject 130 (vehicle in the example shown in FIG. 30) at a rear of the vehicle. As a result, the user, the apparatus, or the like that performs the processing on the first moving image file 56 and the second moving image file 68 can specify, from the first moving image file 56, the information related to the subject 130 and can specify, from the second moving image file 68, the information related to the subject 128. Therefore, for example, it is possible to improve the efficiency of work of collating which image data 16, which is included in the first moving image file 56, corresponds to which image data 18, which is included in the second moving image file 68, or the like.

The vehicle 126 is merely an example, and the first imaging apparatus 10 and the second imaging apparatus 12 may be attached, at positions where the different subjects can be imaged, to another type of vehicle, such as a train or an automatic motorcycle. Further, the embodiment example in which the front and rear of the vehicle 126 are imaged is merely an example. A right diagonal front and left diagonal front of the vehicle may be imaged, a left side and right side of the vehicle may be imaged, or an outside and inside of the vehicle may be imaged. The first imaging apparatus 10 and the second imaging apparatus 12 may be attached to the vehicle such that the different subjects are imaged.

In the above embodiment, the embodiment example has been described in which the first information processing apparatus 20 in the first imaging apparatus 10 executes the first image file creation processing and the second information processing apparatus 36 in the second imaging apparatus 12 executes the second image file creation processing. However, the present disclosed technology is not limited thereto.

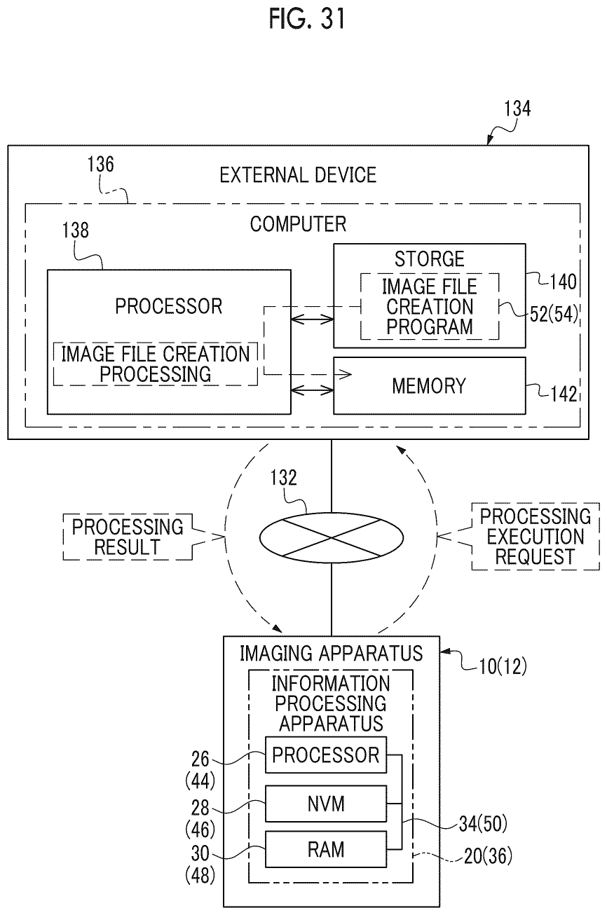

For example, as shown in FIG. 31, the image file creation processing may be executed by a computer 136 in an external device 134 that is communicably connected to the imaging apparatus via a network 132 such as a local area network (LAN) or a wide area network (WAN).

An example of the computer 136 includes a server computer for cloud service.

In the example shown in FIG. 31, the computer 136 comprises a processor 138, a storage 140, and a memory 142. The storage 140 stores an image file creation program.

The imaging apparatus requests, via the network 132, the external device 134 to execute the image file creation processing. In response to this request, the processor 138 of the external device 134 reads out the image file creation program from the storage 140 and executes the image file creation program on the memory 142. The processor 138 performs the image file creation processing in accordance with the image file creation program executed on the memory 142. The processor 138 provides a processing result obtained by executing the image file creation processing to the imaging apparatus via the network 132.

FIG. 31 shows an embodiment example in which the image file creation processing is executed on the external device 134, but this is merely an example. For example, the imaging apparatus and the external device 134 may distribute and execute the image file creation processing, or a plurality of apparatuses including the imaging apparatus and the external device 134 may distribute and execute the image file creation processing.

In the above embodiment, the embodiment example has been described in which the moving image file is generated, but a format of the moving image file may be any one of moving picture experts group (MPEG)-4, H.264, motion jpeg (MJPEG), high efficiency image file format (HEIF), audio video interleave (AVI), QuickTime file format (MOV), windows media video (WMV), or flash video (FLV). From the viewpoint of assigning the metadata (additional information) described in the above embodiment, the moving image data of the HEIF is preferably used. Further, even in a case where a still image file is generated, the present disclosed technology is established. As the still image file in this case, an image file is used in which the additional information can be added to a region different from the image data (that is, a recordable format).

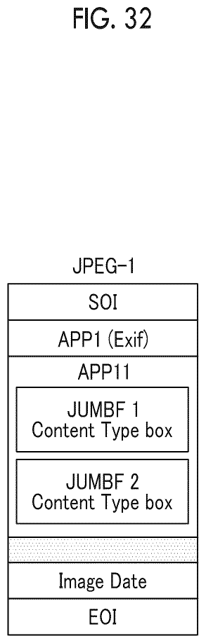

An example of a structure of the image file of the format in which the additional information can be added to the region different from the image data includes a data structure of a joint photographic experts group (JPEG) file corresponding to an exchangeable image file format (Exif) standard, as shown in FIG. 32. Here, the JPEG file is exemplified, but this is merely an example, and the image file is not limited to the JPEG file.

In JPEG XT Part 3, which is a type of JPEG, marker segments “APP1” and “APP11” are provided as regions to which the additional information can be added. The “APP1” includes tag information related to an imaging date and time, imaging place, imaging condition, and the like of the image data. The “APP11” includes a box of a jpeg universal metadata box format (JUMBF) (specifically, for example, boxes of JUMBF1 and JUMBF2), which is a storage region of the metadata.

In the box of JUMBF1, there is a content type box where the metadata is stored, and information can be described in a region thereof in a JavaScript (registered trademark) object notation (JSON) format. A description method of the metadata is not limited to the JSON method, and may be an extensible markup language (XML) method. Further, in the box of JUMBF2, information different from the box of JUMBF1 can be described in the content type box. In the JPEG file, it is possible to create about 60,000 JUMBF boxes as described above.

Further, in the data structure of Exif version 3.0 (Exif 3.0), the region to which the additional information can be added is expanded, as compared with Exif 2.32 of an old version, and specifically, a box region conforming to the JUMBF is added. A plurality of hierarchies may be set in the box region. In this case, the additional information may be stored (that is, written) by changing a content or abstraction of the information in accordance with a rank of the hierarchy. For example, a type of the subject reflected in the image data may be written in a higher rank hierarchy, and a state, attribute, or the like of the subject may be written in a lower rank hierarchy.

An item of the additional information and the number of pieces of additional information that can be added to the image file is changed according to the file format. Further, with update of version information of the image file, the additional information for a new item may be added. The item of the additional information means a viewpoint in adding the additional information (that is, category in which information is classified).

In the above embodiment, the embodiment example has been described in which the NVM stores the image file creation program, but the present disclosed technology is not limited thereto. For example, the image file creation program may be stored in a portable computer-readable non-transitory storage medium, such as a solid state drive (SSD), a USB memory, or a magnetic tape. The image file creation program stored in the non-transitory storage medium is installed in the imaging apparatus. The processor executes image file creation processing in accordance with the image file creation program.

Further, the image file creation program may be stored in a storage device of another computer, a server device, or the like connected to the imaging apparatus via a network, the image file creation program may be downloaded in response to a request of the imaging apparatus, and the image file creation program may be installed in the imaging apparatus.

There is no need to store the entire image file creation program in the storage device of another computer, a server device, or the like connected to the imaging apparatus or the NVM, and a part of the image file creation program may be stored.

Further, the imaging apparatus shown in FIG. 2 includes the information processing apparatus, but the present disclosed technology is not limited thereto. For example, the information processing apparatus may be provided outside the imaging apparatus.

In the above embodiment, the embodiment example has been described in which the present disclosed technology is realized by the software configuration, but the present disclosed technology is not limited thereto. A device including an application specific integrated circuit (ASIC), a field programmable gate array (FPGA), or a programmable logic device (PLD) may be applied.

Further, a combination of a hardware configuration and a software configuration may be used.

As a hardware resource for executing the image file creation processing described in the above embodiment, various processors shown below can be used. Examples of the processor include software, that is, a CPU, which is a general-purpose processor that executes a program to function as the hardware resource for executing the image file creation processing. Further, examples of the processor include a dedicated electronic circuit which is a processor having a circuit configuration designed to be dedicated to execute specific processing, such as the FPGA, the PLD, or the ASIC. A memory is incorporated in or connected to any processor, and any processor uses the memory to execute the image file creation processing.

The hardware resource for executing the image file creation processing may be configured with one of these various processors or may be configured with a combination of two or more processors of the same type or different types (for example, a combination of a plurality of FPGAs or a combination of a CPU and an FPGA). Further, the hardware resource for executing the image file creation processing may be one processor.

As an example of configuring with one processor, first, one processor is configured with a combination of one or more CPUs and software, and there is an embodiment in which this processor functions as the hardware resource for executing the image file creation processing. Second, as represented by System-on-a-chip (SoC) or the like, there is a form in which a processor that realizes all functions of a system including a plurality of hardware resources for executing the image file creation processing into one integrated circuit (IC) chip is used. As described above, the image file creation processing is realized by using one or more of the various processors as the hardware resource.

Furthermore, as the hardware structure of these various processors, more specifically, it is possible to use an electronic circuit in which circuit elements, such as semiconductor elements, are combined. Further, the image file creation processing described above is merely an example. Therefore, it is needless to say that removal of an unnecessary step, addition of a new step, and change of processing procedure may be employed within a range not departing from the gist.

The above contents and the above-shown contents are detailed descriptions for parts according to the present disclosed technology, and are merely examples of the present disclosed technology. For example, the descriptions regarding the configurations, the functions, the actions, and the effects are descriptions regarding an example of the configurations, the functions, the actions, and the effects of the part according to the present disclosed technology. Accordingly, in the contents described and the contents shown hereinabove, it is needless to say that removal of an unnecessary part, or addition or replacement of a new element may be employed within a range not departing from the gist of the present disclosed technology. In order to avoid complication and easily understand the part according to the present disclosed technology, in the contents described and the contents shown hereinabove, the description regarding common general technical knowledge or the like which is not necessarily particularly described for enabling implementation of the present disclosed technology is omitted.

In the present specification, the grammatical concept of “A or B” includes the concept of “any one of A or B” as well as the concept synonymous with “at least one of A or B”. That is, “A or B” includes meaning that it may be only A, only B, or a combination of A and B. In the present specification, in a case where three or more matters are represented by “or” in combination, the same concept as “A or B” is applied.

In a case where all of documents, patent applications, and technical standard described in the specification are incorporated in the specification as references, to the same degree as a case where the incorporation of each of documents, patent applications, and technical standard as references is specifically and individually noted.

What is claimed is:

1. An information processing method comprising:
a linking step of linking first imaging processing of generating a first image file including first image data obtained by imaging a first subject with second imaging processing of generating a second image file including second image data obtained by imaging a second subject;
an acquisition step of acquiring first subject information related to the first subject; and
an assignment step of including the first subject information in second accessory information recorded in the second image file to assign the first subject information to the second image file.

2. The information processing method according to claim 1,
wherein, in the acquisition step, second subject information related to the second subject is acquired as information included in the second accessory information, and
in the assignment step, the second subject information is included in first accessory information recorded in the first image file to assign the second subject information to the first image file.

3. The information processing method according to claim 1,
wherein first accessory information recorded in the first image file and the second accessory information include information in common with each other.

4. The information processing method according to claim 1,
wherein the first image data is moving image data configured of a plurality of first frames, and
first accessory information recorded in the first image file includes first time information related to a corresponding first frame.

5. The information processing method according to claim 4,
wherein, in the assignment step, the first time information is included in the second accessory information to assign the first time information to the second image file.

6. The information processing method according to claim 1,
wherein the second image data is moving image data configured of a plurality of second frames, and
the second accessory information includes second time information related to a corresponding second frame.

7. The information processing method according to claim 6,
wherein, in the assignment step, the second time information is included in first accessory information recorded in the first image file to assign the second time information to the first image file.

8. The information processing method according to claim 1,
wherein first accessory information recorded in the first image file includes information related to a first imaging apparatus that performs the first imaging processing.

9. The information processing method according to claim 8,
wherein, in the assignment step, the information related to the first imaging apparatus is included in the second accessory information to assign the information related to the first imaging apparatus to the second image file.

10. The information processing method according to claim 8,
wherein the information related to the first imaging apparatus includes first position information related to a position of the first imaging apparatus, first direction information related to an imaging direction of the first imaging apparatus, or distance information related to a distance between the first imaging apparatus and a second imaging apparatus that performs the second imaging processing.

11. The information processing method according to claim 8,
wherein the second accessory information includes information related to a second imaging apparatus that performs the second imaging processing.

12. The information processing method according to claim 11,
wherein, in the assignment step, the information related to the second imaging apparatus is included in the first accessory information to assign the information related to the second imaging apparatus to the first image file.

13. The information processing method according to claim 1,
wherein the first subject and the second subject are common subjects.

14. The information processing method according to claim 13,
wherein, in the first imaging processing, a first sensor that images the first subject is used,
in the second imaging processing, a second sensor that images the second subject is used, and
a first output result output from the first sensor and a second output result output from the second sensor have different types from each other.

15. The information processing method according to claim 14,
wherein one of the first output result and the second output result is visible light image data obtained by imaging visible light, and
the other of the first output result and the second output result is invisible light image data obtained by imaging light in a wavelength range higher than or lower than a wavelength range of the visible light.

16. The information processing method according to claim 14,
wherein one of the first output result and the second output result is visible light image data obtained by imaging visible light, and
the other of the first output result and the second output result is distance image data obtained by performing distance measurement.

17. The information processing method according to claim 1,
wherein the first subject and the second subject are different subjects.

18. The information processing method according to claim 17,
wherein a first imaging apparatus that performs the first imaging processing and a second imaging apparatus that performs the second imaging processing are attached to a vehicle.

19. The information processing method according to claim 1,
wherein the first image file is a first moving image file including first moving image data as the first image data, and
the second image file is a second moving image file including second moving image data as the second image data.

20. An information processing apparatus comprising:
a processor,
wherein the processor is configured to:
link first imaging processing of generating a first image file including first image data obtained by imaging a first subject with second imaging processing of generating a second image file including second image data obtained by imaging a second subject;
acquire first subject information related to the first subject; and
include the first subject information in second accessory information recorded in the second image file to assign the first subject information to the second image file.
